(19) United States
(12) Patent Application Publication
(10) Pub. No.: US 2026/0032442 A1
(43) Pub. Date: Jan. 29, 2026

(54) METHOD AND APPARATUS FOR PROVIDING A SECURITY MECHANISM FOR A STEERING OF ROAMING PROCEDURE

(71) Applicant: Nokia Technologies Oy, Espoo (FI)

(72) Inventors: Ranganathan MAVUREDDI DHANASEKARAN, Munich (DE); Jing PING, Chengdu (CN); Saurabh KHARE, Bangalore (IN)

(21) Appl. No.: 19/117,329

(22) PCT Filed: Sep. 30, 2022
(86) PCT No.: PCT/CN2022/123667

§ 371 Date: Mar. 31, 2025

(51) Int. Cl. H04W 12/106; H04W 12/043; H04W 12/06; H04W 60/04; H04W 84/04

(52) U.S. Cl. CPC H04W 12/106; H04W 12/043; H04W 12/06; H04W 60/04; H04W 84/042

(57) ABSTRACT

Methods and apparatus are disclosed for protecting information for a SoR procedure initiated by a user equipment (UE). A method comprises, creating at a UE, a first secured packet which is protected with one or more keys, wherein the first secured packet comprises enhanced steering of roaming (SoR) related information for triggering a SoR procedure; and sending from the UE to a first visited public land mobile network (VPLMN), a message comprising the first secured packet. Each of the one or more keys is a symmetric key, which is available for the UE and a home public land mobile network (HPLMN) of the UE before a primary authentication of an initial registration to the first VPLMN.

### TECHNICAL FIELD

Embodiments of the disclosure generally relate to a security mechanism for a steering of roaming (SoR) procedure, and more particularly, to methods and apparatus for protecting information for a SoR procedure initiated by a user equipment (UE).

### BACKGROUND

Steering of roaming (SoR) is a technique whereby a roaming UE is encouraged to roam to a preferred roamed-to-network indicated by its home public land mobile network (HPLMN). For example, a UE is roaming on one visited public land mobile network (VPLMN), and for some reasons, the UE's HPLMN may want the UE to register on another PLMN. However, a SoR procedure may be encountered with some security threats.

For example, the VPLMN may prevent the roaming UE from moving away to any other visited network, for example, because it wants to maintain the roaming UE on the VPLMN. In order to prevent the roaming UE from moving away to any other visited network, the VPLMN may tamper information for a SoR procedure, such as SoR information sent to the UE, information for triggering the SoR procedure, etc.

Thus, it is necessary to provide a security mechanism for a SoR procedure.

### SUMMARY

This summary is provided to introduce simplified concepts of methods and apparatus for protecting a security mechanism for a SoR procedure. This summary is not intended to identify key features or essential features of the claimed subject matter, nor is it intended to be used to limit the scope of the claimed subject matter.

According to a first aspect of the disclosure, there is provided an apparatus implemented at a UE. The apparatus comprises at least one processor, and at least one memory storing instructions that, when executed by the one or more processors, cause the apparatus at least to: create a first secured packet which is protected with one or more keys, wherein the first secured packet comprises enhanced steering of roaming (SoR) related information element for triggering a SoR procedure; and send to a first visited public land mobile network (VPLMN), a message comprising the first secured packet. Each of the one or more keys is a symmetric key, which is available for the UE and a home public land mobile network (HPLMN) of the UE before a primary authentication of an initial registration to the first VPLMN.

According to a second aspect of the disclosure, there is provided another apparatus implemented at a UE. The apparatus comprises at least one processor, a universal integrated circuit card (UICC) coupled to the one or more processor, and at least one memory storing instructions that, when executed by the one or more processors, cause the apparatus at least to: maintain in the UICC, a first key which is a pre-configured application key shared with a home public land mobile network (HPLMN) of the UE; create a first secured packet which is ciphered by using the first key in the UICC, wherein the first secured packet comprises enhanced steering of roaming (SoR) related information for triggering a SoR procedure; provide integrity protection to the first secured packet by using a second key, which is a key of network layer shared with the HPLMN; and send to a first visited public land mobile network (VPLMN), a message comprising the first secured packet with integrity protection.

According to a third aspect of the disclosure, there is provided an apparatus implemented at a unified data management (UDM) node in a public land mobile network (PLMN). The apparatus comprises at least one processor, and at least one memory storing instructions that, when executed by the one or more processors, cause the apparatus at least to: receive via a first visited PLMN (VPLMN), a message originated from a user equipment (UE) for which the PLMN is a home PLMN (HPLMN), wherein the message comprises a first secured packet which comprises enhanced steering of roaming (SoR) related information for triggering a SoR procedure; enable verification of the first secured packet to retrieve the enhanced SoR related information, by one of the following operations: verifying at the UDM node, the first secured packet by using one or more keys; or sending the first secured packet to a network node which maintains the one or more keys; and obtain SoR information according to the retrieved enhanced SoR related information. Each of the one or more keys is a symmetric key, which is available for the UE and the HPLMN before a primary authentication of an initial registration of the UE to the first VPLMN.

According to a fourth aspect of the disclosure, there is provided an apparatus implemented at another unified data management (UDM) node in a public land mobile network (PLMN). The apparatus comprises at least one processor, and at least one memory storing instructions that, when executed by the one or more processors, cause the apparatus at least to: receive via a first visited PLMN (VPLMN), a message originated from a user equipment (UE) for which the PLMN is a home PLMN (HPLMN), wherein the message comprises a first secured packet which comprises enhanced steering of roaming (SoR) related information for triggering a SoR procedure; send the first secured packet to an authentication server function (AUSF) node which maintains a fourth key for triggering a verification of integrity of the first secured packet, wherein the fourth key is a key of network layer shared with the UE; send the first secured packet to a SoR application function node which maintains a third key shared with the UE for deciphering the first secured packet, wherein the third key is a pre-configured application key; receive from the SoR application function node, at least part of the enhanced SoR related information retrieved from the first secured packet; and obtain SoR information according to the received at least part of the enhanced SoR related information.

According to a fifth aspect of the disclosure, there is provided an apparatus implemented at a steering of roaming (SoR) application function node in a public land mobile network (PLMN). The apparatus comprises at least one processor, and at least one memory storing instructions that, when executed by the one or more processors, cause the apparatus at least to: receive from a unified data management (UDM) node, a message requesting SoR information for a user equipment (UE) which is roaming in a first visited PLMN (VPLMN) and for which the PLMN is a home PLMN (HPLMN), wherein the message comprises a first secured packet which comprises enhanced SoR related information for triggering a SoR procedure; verify the first secured packet with one or more keys to retrieve the enhanced SoR related information; and send at least part of the retrieved enhanced SoR related information to the UDM node. Each of the one or more keys is a symmetric application key, which is pre-configured in the UE and the SoR application function node.

According to a sixth aspect of the disclosure, there is provided an apparatus implemented at an authentication server function (AUSF) node in a public land mobile network (PLMN). The apparatus comprises at least one processor, and at least one memory storing instructions that, when executed by the one or more processors, cause the apparatus at least to: receive from a unified data management (UDM) node, a request message for a user equipment (UE) which is roaming in a first visited PLMN (VPLMN) and for which the PLMN is a home PLMN (HPLMN), wherein the request message comprises a first secured packet which comprises enhanced SoR related information for triggering a SoR procedure; verify the first secured packet with one or more keys to retrieve the enhanced SoR related information; and send the retrieved information element to the UDM node. Each of the one or more keys is a symmetric key of network layer, which is pre-configured in the UE and the AUSF node before a primary authentication of an initial registration of the UE to the first VPLMN.

According to a seventh aspect of the disclosure, there is provided a method performed at a user equipment (UE). The method comprises: creating a first secured packet which is protected with one or more keys, wherein the first secured packet comprises enhanced steering of roaming (SoR) related information element for triggering a SoR procedure; and sending to a first visited public land mobile network (VPLMN), a message comprising the first secured packet. Each of the one or more keys is a symmetric key, which is available for the UE and a home public land mobile network (HPLMN) of the UE before a primary authentication of an initial registration to the first VPLMN.

According to an eighth aspect of the disclosure, there is provided another method performed at a user equipment (UE). The method comprises: maintaining in a universal integrated circuit card (UICC) of the UE, a first key which is a pre-configured application key shared with a home public land mobile network (HPLMN) of the UE; creating a first secured packet which is ciphered by using the first key in the UICC, wherein the first secured packet comprises enhanced steering of roaming (SoR) related information element for triggering a SoR procedure; providing integrity protection to the first secured packet by using a second key, which is a key of network layer shared with the HPLMN; and sending to a first visited public land mobile network (VPLMN), a message comprising the first secured packet with integrity protection.

According to a ninth aspect of the disclosure, there is provided a method performed at a unified data management (UDM) node in a public land mobile network (PLMN). The method comprises: receiving via a first visited PLMN (VPLMN), a message originated from a user equipment (UE) for which the PLMN is a home PLMN (HPLMN), wherein the message comprises a first secured packet which comprises enhanced steering of roaming (SoR) related information for triggering a SoR procedure; enabling verification of the first secured packet to retrieve the enhanced SoR related information, by one of the following operations: verifying at the UDM node, the first secured packet by using one or more symmetric keys; or sending the first secured packet to a network node which maintains the one or more symmetric keys; and obtaining the SoR information according to the enhanced SoR related information in the deciphered secured packet. Each of the one or more keys is a symmetric key, which is available for the UE and the HPLMN before a primary authentication of an initial registration of the UE to the first VPLMN.

According to a tenth aspect of the disclosure, there is provided another method performed at a unified data management (UDM) node in a public land mobile network (PLMN). The method comprises: receiving via a first visited PLMN (VPLMN), a message originated from a user equipment (UE) for which the PLMN is a home PLMN (HPLMN), wherein the message comprises a first secured packet which comprises enhanced steering of roaming (SoR) related information for triggering a SoR procedure; sending the first secured packet to an authentication server function (AUSF) node which maintains a fourth key for verifying integrity of the first secured packet, wherein the fourth key is a key of network layer shared with the UE; sending the first secured packet to a SoR application function node which maintains a third key shared with the UE for deciphering the first secured packet, wherein the third key is a pre-configured application key; receiving from the SOR application function node, at least part of the enhanced SoR related information retrieved from the first secured packet; and obtaining SoR information according to the received at least part of the enhanced SoR information.

According to an eleventh aspect of the disclosure, there is provided a method performed at a steering of roaming (SoR) application function node in a public land mobile network (PLMN). The method comprises: receiving from a unified data management (UDM) node, a message requesting SoR information for a user equipment (UE) which is roaming in a first visited PLMN (VPLMN) and for which the PLMN is a home PLMN (HPLMN), wherein the message comprises a first secured packet comprising enhanced SoR related information for triggering a SoR procedure; verifying the first secured packet with one or more keys to retrieve the enhanced SoR related information; and sending at least part of the retrieved the enhanced SoR related information to the UDM node. Each of the one or more keys is a symmetric application key, which is pre-configured in the UE and the SOR application function node.

According to a twelfth aspect of the disclosure, there is provided a method performed at an authentication server function (AUSF) node application function node in a public land mobile network (PLMN). The method comprises: receiving from a unified data management (UDM) node, a request message for a user equipment (UE) which is roaming in a first visited PLMN (VPLMN) and for which the PLMN is a home PLMN (HPLMN), wherein the request message comprises a first secured packet which comprises enhanced related information for triggering a SoR procedure; verifying the first secured packet with one or more keys to retrieve the enhanced SoR related information; and sending at least part of the retrieved enhanced SoR related information to the UDM node. Each of the one or more keys is a symmetric key of network layer, which is pre-configured in the UE and the AUSF node before a primary authentication of an initial registration of the UE to the first VPLMN.

According to thirteenth aspect of the disclosure, there is provided a computer readable storage medium, on which instructions are stored, when executed by an apparatus, the instructions cause the apparatus to perform any method according to the seventh aspect, the eighth aspect, the ninth aspect, the tenth aspect, the eleventh aspect and the twelfth aspect.

According to fourteenth aspect of the present disclosure, there is provided computer program product comprising instructions which when executed by an apparatus, cause the apparatus to perform any method according to the seventh aspect, the eighth aspect, the ninth aspect, the tenth aspect, the eleventh aspect and the twelfth aspect.

### BRIEF DESCRIPTION OF THE DRAWINGS

Some example embodiments will now be described with reference to the accompanying drawings in which:

FIG. 1 is a flow diagram illustrating an example procedure for providing a list of preferred public land mobile network (PLMN) and access technology combinations;

FIG. 2 is a flow diagram illustrating an example security procedure for providing a list of preferred PLMN and access technology combinations during registration in a VPLMN;

FIG. 3a is a flow diagram illustrating a short message service mobile terminated;

FIG. 3b is a flow diagram illustrating a short message service mobile originated;

FIG. 3c is an exemplary definition of an octet which is used for short message service (SMS);

FIG. 4 is a flow diagram illustrating an example procedure for retrieving secured packet;

FIG. 5 is a flow diagram illustrating an example procedure for protecting information for triggering a SoR procedure by using an application key, according to an embodiment of the present disclosure;

FIG. 6 is a flow diagram illustrating an example procedure for detecting a drop of information for triggering a SoR procedure, according to an embodiment of the present disclosure;

FIG. 7 is a flow diagram illustrating another example procedure for protecting information for triggering a SoR procedure by using an application key to encrypt the SoR info and Kausf for integrity protection, according to an embodiment of the present disclosure;

FIG. 8 is a flow diagram illustrating an example process for generating and reusing symmetric keys from asymmetric key pairs for subscription concealed identifier (SUCI) generation, according to an embodiment of the present disclosure;

FIG. 9 is a flow diagram illustrating an example procedure for protecting information for triggering a SoR procedure by reusing symmetric keys generated in FIG. 8, according to an embodiment of the present disclosure;

FIG. 10 is a flow diagram illustrating an example procedure for protecting information for triggering a SoR procedure by using a key of network layer, according to an embodiment of the present disclosure;

FIGS. 11a and 11b are logic flow charts depicting methods performed at a UE, according to an embodiment of the present disclosure;

FIGS. 12a and 12b are a logic flow charts depicting methods performed at a unified data management (UDM) node, according to an embodiment of the present disclosure;

FIG. 13 is a logic flow chart depicting a method performed at a SoR application function node, according to an embodiment of the present disclosure;

FIG. 14 is a logic flow chart depicting a method performed at an authentication server function (AUSF) node, according to an embodiment of the present disclosure; and

FIG. 15 is a schematic illustrating an example apparatus according to an embodiment of the present disclosure.

### DETAILED DESCRIPTION

Some example embodiments will now be described more fully hereinafter with reference to the accompanying drawings, in which some, but not all embodiments are shown. Indeed, the example embodiments may take many different forms and should not be construed as limited to the embodiments set forth herein; rather, these embodiments are provided so that this disclosure will satisfy applicable legal requirements. Like reference numerals refer to like elements throughout.

Abbreviations that may be found in the specification and/or the drawing figures are defined below, at the end of the detailed description section.

In the following description and claims, unless defined otherwise, all technical and scientific terms used herein have the same meaning as commonly understood by one of ordinary skills in the art to which this disclosure belongs.

References in the present disclosure to “one embodiment”, “an embodiment”, “an example embodiment”, and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and/or processor(s), such as a microprocessor(s) or a portion of a microprocessor(s), that requires software (e.g., firmware) for operation, but the software may not be present when it is not needed for operation.

This definition of “circuitry” applies to all uses of this term in this application, including in any claims. As a further example, as used in this application, the term “circuitry” also covers an implementation of merely a hardware circuit or processor (or multiple processors) or portion of a hardware circuit or processor and its (or their) accompanying software and/or firmware. The term “circuitry” also covers, for example and if applicable to the particular claim element, a baseband integrated circuit or processor integrated circuit for a mobile device or a similar integrated circuit in server, a cellular network device, or other computing or network device.

In the following, certain embodiments are explained with reference to mobile communication devices capable of communication via a wireless cellular system and mobile communication systems serving such mobile communication devices. The mobile communication device or user equipment may comprise any suitable device capable of at least receiving wireless communication of data. For example, the device can be handheld data processing device equipped with radio receiver, data processing and user interface apparatus. Non-limiting examples include a mobile station (MS) such as a mobile phone or what is known as a “smart phone”, a portable computer such as a laptop or a tablet computer provided with a wireless interface card or other wireless interface facility, personal data assistant (PDA) provided with wireless communication capabilities, or any combinations of these or the like. Further examples include wearable wireless devices such as those integrated with watches or smart watches, eyewear, helmets, hats, clothing, ear pieces with wireless connectivity, jewelry and so on, universal serial bus (USB) sticks with wireless capabilities, modem data cards, machine type devices or any combinations of these or the like.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), New Radio (NR) and so on. Furthermore, the communications between two communication entities in one or more communication networks may be performed according to any suitable generation communication protocols, including, but not limited to, the fifth generation (5G), the future sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

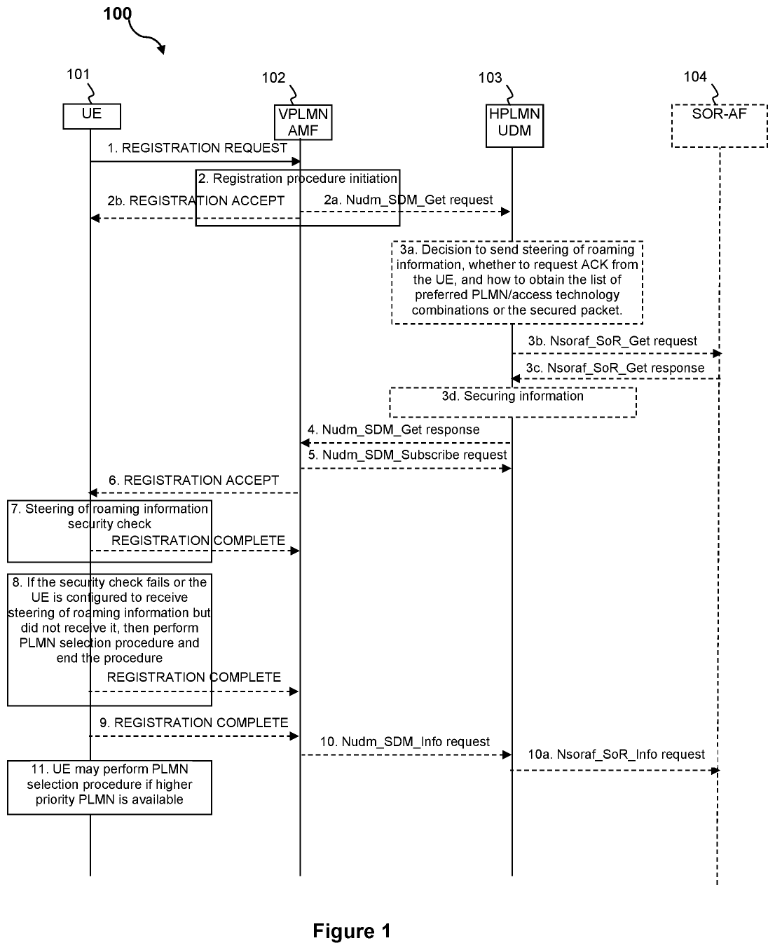

The SoR technique enables a HPLMN to steer a UE roaming in one communication network to another communication network. The HPLMN can update a list of preferred PLMN/access technology combinations at the UE via non-access stratum (NAS) signaling. For example, the HPLMN updates the list of preferred PLMN/access technology combinations, according to the PLMN in which the UE is registered, or when required by HPLMN operator policy. FIG. 1 is a data flow diagram 100 illustrating an example procedure for providing a list of preferred PLMN and access technology combinations when the UE registers with a VPLMN access and mobility management function (AMF). The data flow diagram 100 is according to 3GPP TS 23.122, which is hereby incorporated by reference.

The data flow diagram 100 involves a UE 101, a VPLMN access and mobility management function (AMF) node 102, an HPLMN unified data management (UDM) node 103, and an HPLMN SoR application function (SoR-AF) node 104. The UE 101 is roaming in a PLMN, which is selected as a VPLMN. The AMF 102 is located in the selected VPLMN. The UDM 103 and SoR-AF 104 are located in a HPLMN of the UE 101. The UE 101 may comprise mobile equipment (ME) and a (removable) memory module, namely universal subscriber identity module (USIM).

For example, 3GPP TS 23.122 provides the following description for the data flow diagram 100.
Step 1) The UE to the VPLMN AMF: The UE initiates initial registration, emergency registration or mobility registration update procedure to the VPLMN AMF by sending REGISTRATION REQUEST message with the 5GS registration type information element (IE) indicating “initial registration”, “emergency registration” or “mobility registration updating”;
Step 2) Upon receiving REGISTRATION REQUEST message, the VPLMN AMF executes the registration procedure as defined in clause 4.2.2.2.2 of 3GPP TS 23.502. As part of the registration procedure:
   a) if the VPLMN AMF does not have subscription data for the UE, the VPLMN AMF invokes Nudm_SDM_Get service operation to the HPLMN UDM to get amongst other information the Access and Mobility Subscription data for the UE (see step 14b in clause 4.2.2.2.2 of 3GPP TS 23.502); or
   b) if the VPLMN AMF already has subscription data for the UE and:
      i) the 5GS registration type IE in the received REGISTRATION REQUEST message indicates “initial registration” and the “SoR Update Indicator for Initial Registration” field in the UE context is set to ‘the UDM requests the AMF to retrieve SoR information when the UE performs NAS registration type “initial registration”’ as specified in table 5.2.2.2.2-1 of 3GPP TS 23.502); or
      ii) the 5GS registration type IE in the received REGISTRATION REQUEST message indicates “emergency registration” and the “SoR Update Indicator for Emergency Registration” field in the UE context is set to ‘the UDM requests the AMF to retrieve SoR information when the UE performs NAS registration type “emergency registration” as specified in table 5.2.2.2.2-1 of 3GPP TS 23.502);
      then the VPLMN AMF invokes Nudm_SDM_Get service operation message (as shown in step 2a) to the HPLMN UDM to retrieve the steering of roaming information (see step 14b in clause 4.2.2.2.2 of 3GPP TS 23.502);
      otherwise the VPLMN AMF sends a REGISTRATION ACCEPT message (as shown step 2b) without the steering of roaming information to the UE and steps 3a, 3b, 3c, 3d, 4, 5, 6 are skipped;
Step 3a) If the user subscription information indicates to send the steering of roaming information due to initial registration in a VPLMN, then the HPLMN UDM shall provide the steering of roaming information to the UE when the UE performs initial registration in a VPLMN, otherwise the HPLMN UDM may provide the steering of roaming information to the UE, based on operator policy. If the UE is performing initial registration or emergency registration, the HPLMN UDM shall delete the stored “ME support of SOR-CMCI” indicator, if any.
NOTE 1: Based on operator deployment and policy, if the UDM receives the list of preferred PLMN/access technology combinations from the UDR, and the UDM supports communication with the secured packet application function (SP-AF), the UDM can send this list to the SP-AF requesting it to provide this information in a secured packet as defined in 3GPP TS 29.544.
   If the HPLMN UDM is to provide the steering of roaming information to the UE when the UE performs the registration in a VPLMN, and the HPLMN policy for the SOR-AF invocation is absent then steps 3b and 3c are not performed and the HPLMN UDM obtains the available list of preferred PLMN/access technology combinations or the available secured packet (i.e. all retrieved from the UDR). In addition, if the HPLMN UDM obtains the list of preferred PLMN/access technology combinations and the “ME support of SOR-CMCI” indicator is stored for the UE, then the HPLMN UDM shall obtain the Steering of roaming connected mode control information (SOR-CMCI), if available, otherwise the HPLMN UDM shall not obtain the SOR-CMCI. If the SOR-CMCI is provided then the HPLMN UDM may indicate to the UE to store the SOR-CMCI in the ME by providing the “Store the SOR-CMCI in the ME” indicator.
NOTE 1a: The secured packet obtained by the UDM can include SOR-CMCI only if the “ME support of SOR-CMCI” indicator is stored for the UE and the USIM of the indicated SUPI supports SOR-CMCI. Otherwise if only the “ME support of SOR-CMCI” indicator is stored for the UE, then SOR-CMCI, if any, cannot be included in the secured packet.
   If the HPLMN UDM is to provide the steering of roaming information to the UE when the UE performs the registration in a VPLMN, and the HPLMN policy for the SOR-AF invocation is present, then the HPLMN UDM obtains the list of preferred PLMN/access technology combinations, SOR-CMCI, if any, or the secured packet from the SOR-AF using steps 3b and 3c;
Step 3b) The HPLMN UDM to the SOR-AF: Nsoraf_SoR_Get request (VPLMN ID, SUPI of the UE, access type (see 3GPP TS 29.571)). The VPLMN ID and the access type parameters, indicating where the UE is registering, are stored in the HPLMN UDM;
Step 3c) The SOR-AF to the HPLMN UDM: Nsoraf_SoR_Get response (the list of preferred PLMN/access technology combinations the SOR-CMCI, if any, and the “Store the SOR-CMCI in the ME” indicator, if any, or the secured packet, or neither of them);
   Based on the information received in step 3b and any operator specific criteria, the SOR-AF may either:
      include the list of preferred PLMN/access technology combinations, the SOR-CMCI, if any, and optionally the “Store the SOR-CMCI in the ME” indicator, if any;
      provide the secured packet in the Nsoraf_SoR_Get response; or
      provide the Nsoraf_SoR_Get response with neither of the information above.
   If the SOR-AF includes the list of preferred PLMN/access technology combinations and the ME supports the SOR-CMCI, the SOR-AF may provide the SOR-CMCI and optionally the “Store the SOR-CMCI in the ME” indicator, otherwise the SOR-AF shall provide neither the SOR-CMCI nor the “Store the SOR-CMCI in the ME” indicator.
NOTE 2: In this version of the specification, when the access type where the UE is registering indicates 3GPP access, then the UE is registering over the NG-RAN access technology.
NOTE 3: Based on operator deployment and policy, if the UDM receives the list of preferred PLMN/access technology combinations, and the SOR-CMCI, if any, in the Nsoraf_SoR_Get response from the SOR-AF, and the UDM supports communication with SP-AF, it can send this list, and the SOR-CMCI, if any, to SP-AF requesting it to provide this information in a secured packet as defined in 3GPP TS 29.544.
NOTE 4: The SOR-AF can include a different list of preferred PLMN/access technology combinations, different SOR-CMCI, if any, and different “Store the SOR-CMCI in the ME” indicator, if any, or a different secured packet for each Nsoraf_SoR_Get request even if the same VPLMN ID, the SUPI of the UE, and the access type are provided to the SOR-AF.
NOTE 5: The SOR-AF can subscribe to the HPLMN UDM to be notified about the changes of the roaming status of the UE identified by SUPI.
NOTE 5a: The SOR-AF can determine that the mobile equipment (ME) supports the SOR-CMCI if the Nsoraf_SoR_Info service operation has returned the “ME support of SOR-CMCI” indicator.
NOTE 5b: The secured packet provided by the SOR-AF can include steering of roaming connected mode control information (SOR-CMCI) only if the SOR-AF has determined that the ME UE supports the SOR-CMCI and the USIM of the indicated SUPI supports SOR-CMCI. Otherwise if only the “ME support of SOR-CMCI” indicator is stored for the UE, then SOR-CMCI, if any, cannot be included in the secured packet.
NOTE 5c: The secured packet provided by the SOR-AF does not include the “Store the SOR-CMCI in the ME” indicator.
Step 3d) The HPLMN UDM forms the steering of roaming information as specified in 3GPP TS 33.501 from:
   the list of preferred PLMN/access technology combinations, the SOR-CMCI, if any, and the “Store the SOR-CMCI in the ME” indicator, if any, or the secured packet obtained in step 3a; or
   the list of preferred PLMN/access technology combinations and the SOR-CMCI, if any, and the “Store the SOR-CMCI in the ME” indicator, if any, or the secured packet, obtained in step 3c.
If:
   neither the list of preferred PLMN/access technology combinations nor the secured packet was obtained in steps 3a or 3c; or
   the SOR-AF has not sent to the HPLMN UDM an Nsoraf_SoR_Get response (step 3c) within an operator defined time after the HPLMN UDM sending to the SOR-AF an Nsoraf_SoR_Get request (step 3b);
NOTE 6: Stage 3 to define the timer needed for the SOR-AF to respond to the HPLMN UDM. The max time needs to be defined considering that this procedure is part of the Registration procedure.
   and the UE is performing initial registration in a VPLMN and the user subscription information indicates to send the steering of roaming information due to initial registration in a VPLMN, then the HPLMN UDM forms the steering of roaming information as specified in 3GPP TS 33.50 from the HPLMN indication that ‘no change of the “Operator Controlled PLMN Selector with Access Technology” list stored in the UE is needed and thus no list of preferred PLMN/access technology combinations is provided’;
Step 4) The HPLMN UDM to the VPLMN AMF: The HPLMN UDM sends a response to the Nudm_SDM_Get service operation to the VPLMN AMF, which includes the steering of roaming information within the Access and Mobility Subscription data. The Access and Mobility Subscription data type is defined in clause 5.2.3.3.1 of 3GPP TS 23.502).
NOTE 6a: The UDM cannot provide the SOR-CMCI, if any, to the VPLMN AMF which does not support receiving SoR transparent container (see 3GPP TS 29.503).
   If the UE is performing initial registration or emergency registration and the HPLMN UDM supports SOR-CMCI, the HPLMN shall request the UE to acknowledge the successful security check of the received steering of roaming information, by providing the indication as part of the steering of roaming information in the Nudm_SDM_Get response service operation. Otherwise, the HPLMN may request the UE to acknowledge the successful security check of the received steering of roaming information, by providing the indication as part of the steering of roaming information in the Nudm_SDM_Get response service operation;
Step 5) The VPLMN AMF to the HPLMN UDM: As part of the registration procedure, the VPLMN AMF also invokes Nudm_SDM_Subscribe service operation to the HPLMN UDM to subscribe to notification of changes of the subscription data (e.g. received in step 4) including notification of updates of the steering of roaming information included in the Access and Mobility Subscription data (see step 14c in clause 4.2.2.2.2 of 3GPP TS 23.502);
Step 6) The VPLMN AMF to the UE: The VPLMN AMF shall transparently send the received steering of roaming information to the UE in the REGISTRATION ACCEPT message;
Step 7) If the steering of roaming information is received and the security check is successful, then:
   a) if the UDM has not requested an acknowledgement from the UE, then the UE shall send the REGISTRATION COMPLETE message to the serving AMF without including an SOR transparent container;
   b) if the steering of roaming information contains a secured packet (see 3GPP TS 31.115):
      the ME shall upload the secured packet to the USIM using procedures in 3GPP TS 31.111, if the service “data download via SMS Point-to-point” is allocated and activated in the USIM Service Table (see 3GPP TS 31.102);
NOTE 7: How the ME handles UICC responses and failures in communication between the ME and UICC is implementation specific and out of scope of this release of the specification.
   if the UDM has not requested an acknowledgement from the UE and:
      A) the ME receives a USAT REFRESH with command qualifier (3GPP TS 31.111) of type “Steering of Roaming” and either a SOR-CMCI is included, or the UE is configured with the SOR-CMCI, the UE shall perform items a), b) and c) of the procedure for steering of roaming in clause 4.4.6, and if the UE is in automatic network selection mode then it shall apply the actions in clause C.4.2. In this case steps 8 to 11 are skipped; or
      B) the ME receives a USAT REFRESH command qualifier (3GPP TS 31.111) of type “Steering of Roaming” and neither a SOR-CMCI is included, nor the UE is configured with the SOR-CMCI, it shall perform items a), b) and c) of the procedure for steering of roaming in clause 4.4.6 and if:
         i) the UE has a list of available and allowable PLMNs in the area and based on this list or any other implementation specific means the UE determines that there is a higher priority PLMN than the selected VPLMN; or
         ii) the UE does not have a list of available and allowable PLMNs in the area and is unable to determine whether there is a higher priority PLMN than the selected VPLMN using any other implementation specific means;
         and the UE is in automatic network selection mode, then the UE shall either:
         i) release the current N1 NAS signaling connection locally and then attempt to obtain service on a higher priority PLMN as specified in clause 4.4.3.3 by acting as if timer T that controls periodic attempts has expired. In this case, steps 8 to 11 are skipped. The UE shall suspend the transmission of 5GSM messages until the N1NAS signaling is released. If the UE has an established emergency PDU session (see 3GPP TS 24.501), the receipt of the steering of roaming information shall not trigger the release of the N1 NAS signaling connection. The UE shall release the current N1 NAS signaling connection locally subsequently after the emergency PDU session is released; or
         ii) not release the current N1 NAS signaling connection locally (e.g. if the UE has established PDU session(s)) and skip steps 8 to 10;
   c) if the steering of roaming information contains the list of preferred PLMN/access technology combinations, the ME shall replace the highest priority entries in the “Operator Controlled PLMN Selector with Access Technology” list stored in the ME with the received list of preferred PLMN/access technology combinations, and delete the PLMNs identified by the list of preferred PLMN/access technology combinations from the Forbidden PLMN list and from the Forbidden PLMNs for GPRS service list, if they are present in these lists. Additionally, if:
      i) the UE has a list of available and allowable PLMNs in the area and based on this list or any other implementation specific means the UE determines that there is a higher priority PLMN than the selected VPLMN; or
      ii) the UE does not have a list of available and allowable PLMNs in the area and is unable to determine whether there is a higher priority PLMN than the selected VPLMN using any other implementation specific means;
      and the UE is in automatic network selection mode:
      A) if the UE is configured with the SOR-CMCI or received the SOR-CMCI over N1 NAS signaling, the UE shall apply the actions in clause C.4.2. In this case steps 8 to 11 are skipped;
      B) otherwise, the UE shall:
         i) release the current N1 NAS signaling connection locally and then attempt to obtain service on a higher priority PLMN as specified in clause 4.4.3.3 by acting as if timer T that controls periodic attempts has expired. In this case, steps 8 to 11 are skipped. The UE shall suspend the transmission of 5GSM messages until the N1 NAS signaling is released. If the UE has an established emergency PDU session (see 3GPP TS 24.501), the receipt of the steering of roaming information shall not trigger the release of the N1 NAS signaling connection. The UE shall release the current N1 NAS signaling connection locally subsequently after the emergency PDU session is released. If the UE needs to disable the N1 mode capability (see 3GPP TS 24.501) and there is no emergency service pending, the UE shall first attempt to obtain service on a higher priority PLMN as described in this step, and if no higher priority PLMN can be selected but the last registered PLMN is selected, then the UE shall disable the N1 mode capability; or
         ii) not release the current N1 NAS signaling connection locally (e.g. if the UE has established PDU session(s)) and skip steps 8 to 10;
NOTE 8: When the UE is in the manual mode of operation or the current chosen VPLMN is part of the “User Controlled PLMN Selector with Access Technology” list, the UE stays on the VPLMN.
Step 8) If the UE's USIM is configured with indication that the UE is to receive the steering of roaming information due to initial registration in a VPLMN, but neither the list of preferred PLMN/access technology combinations nor the secured packet nor the HPLMN indication that ‘no change of the “Operator Controlled PLMN Selector with Access Technology” list stored in the UE is needed and thus no list of preferred PLMN/access technology combinations is provided’ is received in the REGISTRATION ACCEPT message, when the UE performs initial registration in a VPLMN or if the steering of roaming information is received but the security check is not successful, then the UE shall:
   a) if the SOR transparent container is included in the REGISTRATION ACCEPT message, send the REGISTRATION COMPLETE message to the serving AMF without including an SOR transparent container;
   b) if the current chosen VPLMN is not contained in the list of “PLMNs where registration was aborted due to SOR”, and is not part of “User Controlled PLMN Selector with Access Technology” list and the UE is not in manual mode of operation, release the current N1 NAS signaling connection locally and attempt to obtain service on a higher priority PLMN as specified in clause 4.4.3.3 by acting as if timer T that controls periodic attempts has expired, with an exception that the current PLMN is considered as lowest priority, and skip steps 9 to 11. The UE shall suspend the transmission of 5GSM messages until the N1 NAS signaling is released. If the UE has an established emergency PDU session (see 3GPP TS 24.501), the UE shall release the current N1 NAS signaling connection locally after the release of the emergency PDU session. If the UE needs to disable the N1 mode capability (see 3GPP TS 24.501) and there is no emergency service pending, the UE shall first attempt to obtain service on a higher priority PLMN as described in this step, and if no higher priority PLMN can be selected but the last registered PLMN is selected, then the UE shall disable the N1 mode capability; and
   c) if the current chosen VPLMN is not contained in the list of “PLMNs where registration was aborted due to SOR”, store the PLMN identity in the list of “PLMNs where registration was aborted due to SOR”;
NOTE 9: When the UE is in the manual mode of operation or the current chosen VPLMN is part of the “User Controlled PLMN Selector with Access Technology” list, the UE stays on the VPLMN.
Step 9) The UE to the VPLMN AMF: If the UDM has requested an acknowledgement from the UE and the UE verified that the steering of roaming information has been provided by the HPLMN in step 7, then:
   a) the UE sends the REGISTRATION COMPLETE message to the serving AMF with an SOR transparent container including the UE acknowledgement;
   b) the UE shall set the “ME support of SOR-CMCI” indicator in the header of the SOR transparent container to “supported”; and
   c) if:
      the steering of roaming information contained a secured packet, then when the UE receives the USAT REFRESH command qualifier of type “Steering of Roaming” and neither a SOR-CMCI is included, nor the UE is configured with the SOR-CMCI, it performs items a), b) and c) of the procedure for steering of roaming in clause 4.4.6;
      the steering of roaming information contained a secured packet, then when the UE receives a USAT REFRESH with command qualifier (3GPP TS 31.111 [41]) of type “Steering of Roaming” and either a SOR-CMCI is included, or the UE is configured with the SOR-CMCI, the UE shall perform items a), b) and c) of the procedure for steering of roaming in clause 4.4.6 and if the UE is in automatic network selection mode then it shall apply the actions in clause C.4.2, and step 11 is skipped; or
      the steering of roaming information contains the list of preferred PLMN/access technology combinations, the UE is configured with the SOR-CMCI or received the SOR-CMCI over N1 NAS signaling, and the UE is in automatic network selection mode, then the UE shall apply the actions in clause C.4.2, and step 11 is skipped;
Step 10) The VPLMN AMF to the HPLMN UDM: If an SOR transparent container is received in the REGISTRATION COMPLETE message, the AMF uses the Nudm_SDM_Info service operation to provide the received SOR transparent container to the UDM. If the HPLMN decided that the UE is to acknowledge the successful security check of the received steering of roaming information in step 4, the UDM verifies that the acknowledgement is provided by the UE as specified in 3GPP TS 33.501. If the “ME support of SOR-CMCI” indicator in the header of the SOR transparent container is set to “supported”, then the HPLMN UDM shall store the “ME support of SOR-CMCI” indicator, otherwise the HPLMN UDM shall delete the stored “ME support of SOR-CMCI” indicator, if any.
NOTE 9a: The UDM cannot receive the “ME support of SOR-CMCI” indicator from the VPLMN AMF which does not support receiving SoR transparent container (see 3GPP TS 29.503 [78]).
Step 10a) The HPLMN UDM to the SOR-AF: Nsoraf SoR Info (SUPI of the UE, successful delivery, “ME support of SOR-CMCI” indicator, if any). If the HPLMN policy for the SOR-AF invocation is present and the HPLMN UDM received and verified the UE acknowledgement in step 10, then the HPLMN UDM informs the SOR-AF about successful delivery of the list of preferred PLMN/access technology combinations, or of the secured packet to the UE. If the “ME support of SOR-CMCI” indicator is stored for the UE, the HPLMN UDM shall include the “ME support of SOR-CMCI” indicator; and
NOTE 9b: How the SOR-AF determines that the USIM for the indicated SUPI supports SOR-CMCI is implementation specific.
Step 11) If the UE has a list of available PLMNs in the area and based on this list the UE determines that there is a higher priority PLMN than the selected VPLMN and the UE is in automatic network selection mode, then the UE shall attempt to obtain service on a higher priority PLMN as specified in clause 4.4.3.3 by acting as if timer T that controls periodic attempts has expired after the release of the N1 NAS signaling connection. If the N1 NAS signaling connection is not released after implementation dependent time, the UE may locally release the N1 signaling connection except when the UE has an established emergency PDU session (see 3GPP TS 24.501).
When the UE performs initial registration for emergency services (see 3GPP TS 24.501 and 3GPP TS 23.502 [63]) while the UE has a valid USIM and the AMF performs the authentication procedure, then based on HPLMN policy, the SOR procedure described in this clause may apply.
If:
   the UE in manual mode of operation encounters scenario mentioned in step 8 above; and
   upon switching to automatic network selection mode, the UE remembers that it is still registered on the PLMN where the missing or security check failure of SOR information was encountered as described in clause 8;
the UE shall wait until it moves to idle mode or 5GMM-CONNECTED mode with RRC inactive indication (see 3GPP TS 24.501) before attempting to obtain service on a higher priority PLMN as specified in clause 4.4.3.3, by acting as if timer T that controls periodic attempts has expired, with an exception that the current registered PLMN is considered as lowest priority. If the UE has an established emergency PDU session, then the UE shall attempt to perform the PLMN selection subsequently after the emergency PDU session is released.
NOTE 10: The receipt of the steering of roaming information by itself does not trigger the release of the emergency PDU session.
NOTE 11: The list of available and allowable PLMNs in the area is implementation specific.

In the procedure of FIG. 1, the SoR-AF 104 may provide a list of preferred PLMN/access technology combinations and a secured packet in the Nsoraf_SoR_Get response to the HPLMN UDM 103, at step 3c. The HPLMN UDM 103 may forms steering of roaming information from the list of preferred PLMN/access technology combinations and the secured packet, at step 3d. The steering of roaming information which contains the secured packet is delivered to the UE 101 (actually to the ME of the UE 101), via the VPLMN AMF 102, as shown at steps 4 and 6. The ME shall upload the secured packet to the USIM. The USIM may handle the secured packet, e.g., through a service “data download via SMS Point-to-point”, which would be introduced later. The secured packet may be used to ensure confidentiality of the SoR information transmitted from the SoR-AF 104 to the UE 101.

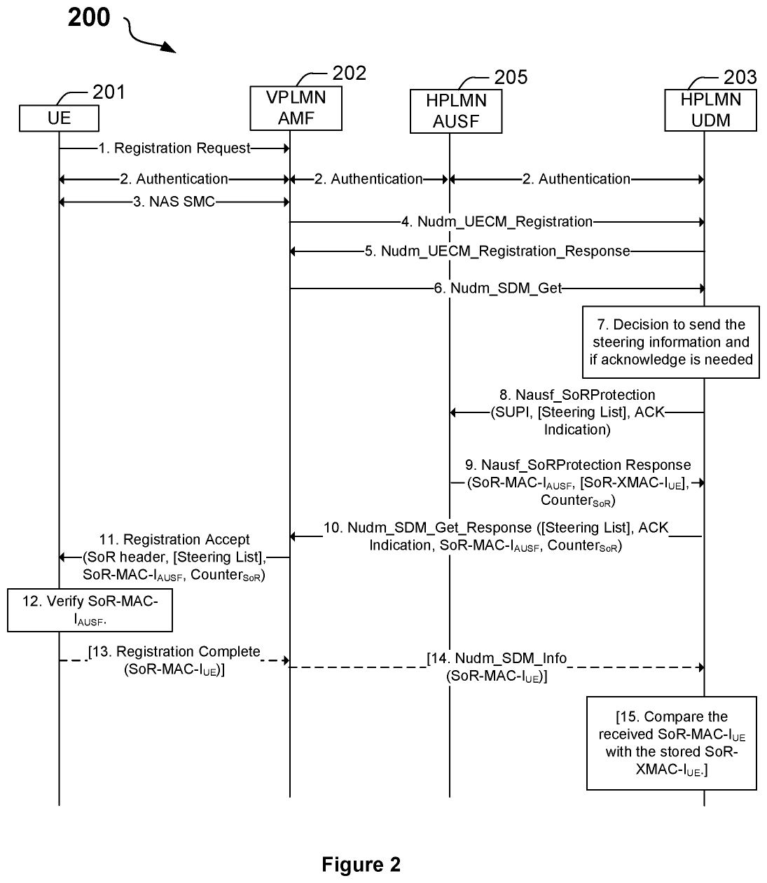

FIG. 2 is a flow diagram 200 illustrating an example security procedure for the data flow of FIG. 1. The data flow diagram 200 is according to 3GPP TS 33.501, which is hereby incorporated by reference. The data flow diagram 200 involves a UE 201, a VPLMN AMF node 202, an HPLMN UDM node 203, and an HPLMN authentication server function (AUSF) node 205. The UE 201, VPLMN AMF 202 and HPLMN UDM 203 may be same as the UE 101, the VPLMN AMF 102 and the HPLMN UDM 103, respectively. The HPLMN AUSF 205 is located in the HPLMN of the UE 201.

For example, 3GPP TS 33.501 provides the following description for the data flow diagram 200.
Step 1) The UE initiates registration by sending Registration Request message to the VPLMN AMF.
Steps 2-3) The VPLMN AMF executes the registration procedure as defined in sub-clause 4.2.2.2.2 of 3GPP TS 23.502. As part of the registration procedure, the VPLMN AMF executes primary authentication of the UE and then initiates the NAS SMC procedure, after the authentication is successful.
Steps 4-5) The VPLMN AMF invokes the Nudm_UECM_Registration message to the UDM and registers access with the UDM as per step 14a in sub-clause 4.2.2.2.2 of 3GPP TS 23.502.
Step 6) The VPLMN AMF invokes Nudm_SDM_Get service operation message to the UDM to get amongst other information the Access and Mobility Subscription data for the UE (see step 14b in sub-clause 4.2.2.2.2 of 3GPP TS 23.502).
Step 7) The UDM decides to send the Steering of Roaming Information, and obtains a list of preferred PLMN/access technology combinations and optional additional SoR information (e.g. SOR-CMCI and the “Store the SOR-CMCI in the ME” indicator), or a secured packet list as described in TS 23.122.
NOTE 1: Additional SoR information (e.g. SOR-CMCI and the “Store the SOR-CMCI in the ME” indicator) can only be added when the AMF supports SoR transparent container.
   If the UDM determines that the UE is configured to not expect to receive Steering of Roaming Information at initial registration and if the UDM determines that no change of the “Operator Controlled PLMN Selector with Access Technology” list stored in the UE is needed, then the UDM may not piggyback Steering of Roaming Information at all in the Nudm_SDM_Get response and hence the following steps are omitted.
Steps 8-9) The UDM shall invoke Nausf_SoRProtection service operation message to the AUSF to get SoR-MAC-IAUSF and CounterSoR as specified in sub-clause 14.1.3 of TS 33.501. The UDM shall select the AUSF that holds the latest KAUSF of the UE.
If the HPLMN decides that the UE is to acknowledge the successful security check of the received Steering of Roaming Information, then the UDM shall set accordingly the ACK Indication included in the Nausf_SoRProtection service operation message to signal that it also needs the expected SoR-XMAC-IUE, as specified in sub-clause 14.1.3 of this document.
NOTE 2: At reception of Nausf_SoRProtection_Protect request from the UDM, if the SOR header is not included in the request, the AUSF constructs the SOR header, as described in clause 9.11.3.51 of TS 24.501 [35], based on the information received from the UDM, i.e. ACK Indication and list of preferred PLMN/access technology combinations or secured packet (if provided); otherwise, if the SoR header is contained in the request, the AUSF uses the received SoR header in the calculation of SoR-MAC-IAUSF.
   The details of the CounterSoR are specified in sub-clause 6.14.2.3 of this document. The inclusion of the Steering List and the SoR header in the calculation of SOR-MAC-IAUSF allows the UE to verify that the received Steering of Roaming Information is not tampered with or removed by the VPLMN. The expected SoR-XMAC-IUE allows the UDM to verify that the UE received the Steering of Roaming Information.
Step 10) The UDM responds to the Nudm_SDM_Get service operation to the VPLMN AMF, which shall include the SoR transparent container as specified in clause 6.1.6.3.2 of TS 29.503 if the VPLMN AMF support SoR transparent container, or shall include individual IEs comprising the ACK Indication, the list of preferred PLMN/access technology combinations or secured packet (if provided), SoR-MAC-IAUSF and CounterSoR within the Access and Mobility Subscription data. If the UDM requests an acknowledgement, it shall temporarily store the expected SoR-XMAC-IUE.
Step 11) If the SoR transparent container is received from the UDM, the VPLMN AMF shall include the received SoR transparent container in the Registration Accept message and send it to the UE. If the individual IEs are received from the UDM, the VPLMN AMF shall construct the SOR header based on the ACK Indication and the list of preferred PLMN/access technology combinations or secured packet (if provided) received from the UDM and include it in the SOR transparent container as specified in clause 9.11.3.51 of TS 24.501 [35]. The vPLMN shall also include SoR-MAC-IAUSF and CounterSoR (both also received from the UDM) in the constructed SoR transparent container, and convey the constructed SoR transparent container to the UE in the Registration Accept message.
Step 12) On receiving the Registration Accept message with the SoR transparent container from the AMF the UE shall calculate the SoR-MAC-IAUSF in the same way as the AUSF (as specified in Annex A.17) on the SoR transparent container, including the CounterSoR and the SoR header, and verifies whether it matches the SoR-MAC-IAUSF value received in the Registration Accept message. Based on the SoR-MAC-IAUSF verification outcome, the behaviour of the UE is specified in TS 23.122.
Step 13) If the UDM has requested an acknowledgement from the UE and the UE verified that the SoR transparent container received in step 12 has been provided by the HPLMN, then the UE shall send the Registration Complete message to the serving AMF. The UE shall generate the SoR-MAC-IUE as specified in Annex A.18 of TS 33.501 and includes the generated SoR-MAC-IUE in a SOR transparent container in the Registration Complete message.
Step 14) The AMF sends a Nudm_SDM_Info request message to the UDM. If a transparent container with the SoR-MAC-IUE was received in the Registration Complete message, then if the AMF supports SoR transparent container, the AMF shall include the received SoR transparent container in SoR transparent container in the Nudm_SDM_Info request message, otherwise, the AMF shall include the SoR-MAC-IUE in the received SoR transparent container in the Nudm_SDM_Info request message.
Step 15) If the HPLMN indicated that the UE is to acknowledge the successful security check of the received Steering of Roaming Information in step 10, then the UDM shall compare the received SoR-MAC-I_{UE} with the expected SOR-XMAC-I_{UE} that the UDM stored temporarily in step 10.

In the procedure of FIG. 2, the VPLMN AMF 202 would trigger primary authentication using a subscription concealed identifier (SUCI) of the UE 201, as shown at step 2. A UE specific home key called K_{AUSF} is established between the UE 201 and its HPLMN resulting from the primary authentication procedure. After a successful completion of a latest primary authentication, the AUSF 205 shall store the latest K_{AUSF}, and the UE 201 shall also store the latest K_{AUSF} in its ME or USIM. The K_{AUSF} may be utilized to provide integrity protection for SoR information and the secured packet, as shown in steps 8-15. In step 9, the AUSF 205 calculates the SOR-MAC-I_{AUSF} using UE specific home key (K_{AUSF}), the Steering Information List and ACK Indication received from the requester UDM 203 and delivers the SoR-MAC-I_{AUSF} and Counter_{SoR} to the UDM 203. If the ACK Indication input is set to indicate that the acknowledgement is requested, then the AUSF 205 shall compute the SoR-XMAC-I_{UE} and return it in the response.

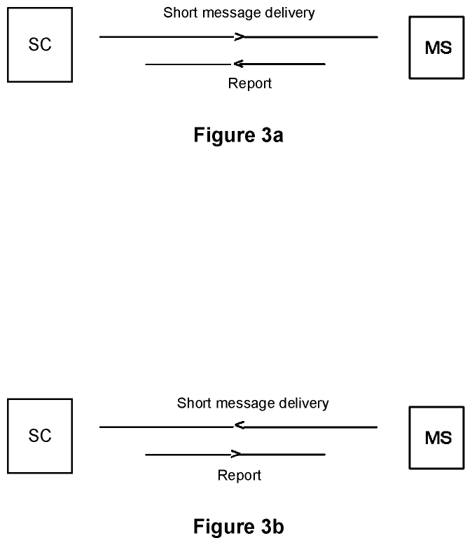

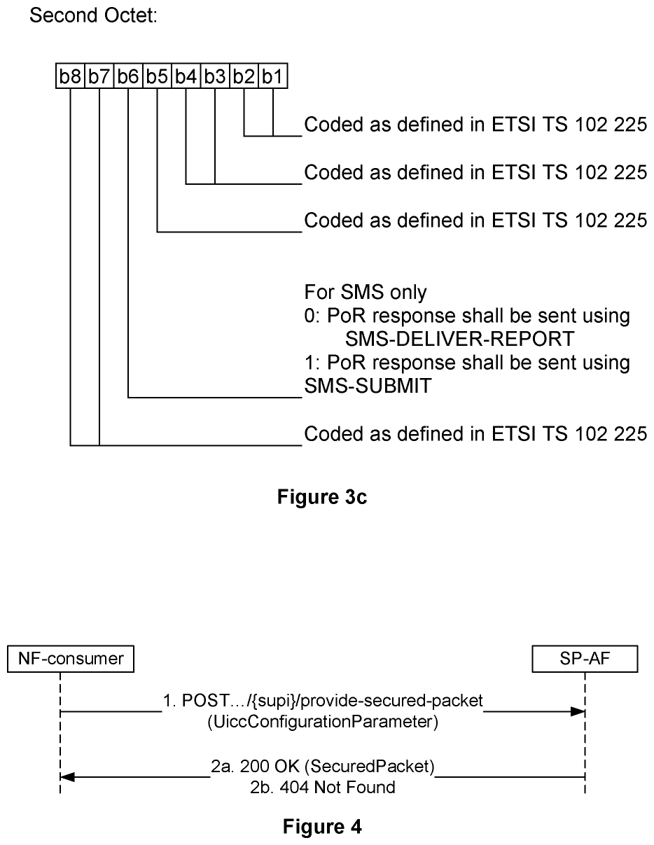

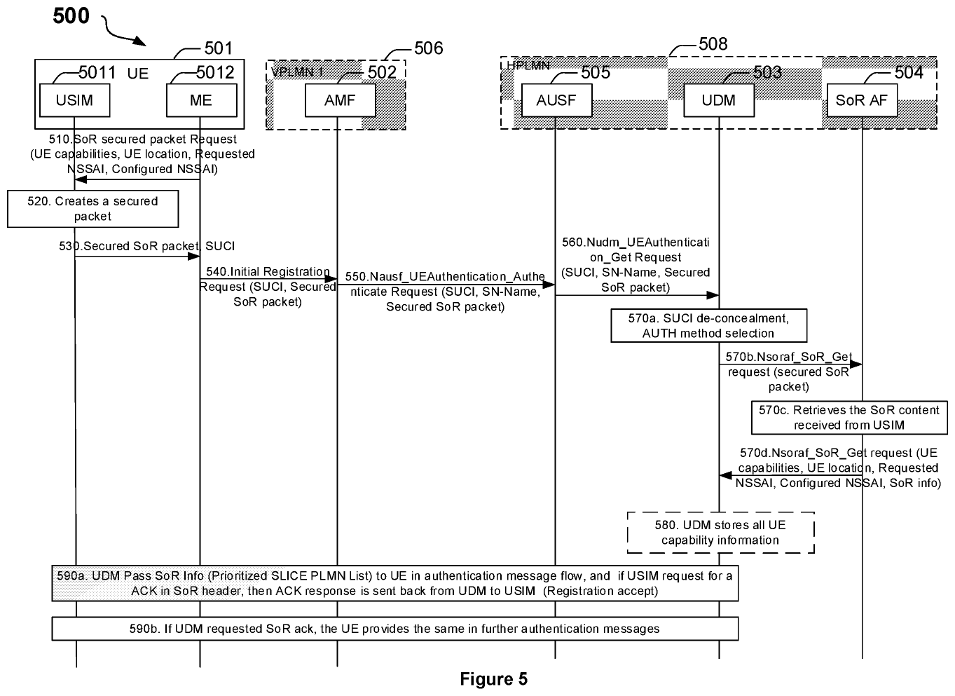

As discussed above, the USIM (or UICC) may handle the secured packet through a service “data download via SMS Point-to-point”. The short message service (SMS) comprises two basic services: short message mobile terminated (SM MT) and short message mobile originated (SM MO). The text messages to be transferred by means of the SM MT or SM MO contain up to 140 octets. FIGS. 3a and 3b illustrates a data flow of these two kinds of SMS.

An active mobile station (or UE) shall be able to receive a short message transport protocol data unit (TPDU) (SMS-DELIVER) as shown in FIG. 3a, at any time, independently of whether or not there is a speech or data call in progress. The UE is a switched-on mobile station with a subscriber identity module (SIM)/universal integrated circuit card (UICC) module attached. A report shall always be returned to the SMS service center (SMS-SC); either confirming that the UE has received the short message, or informing the SMS-SC that it was impossible to deliver the short message TPDU to the UE, including the reason why.

An UE shall be able to submit a short message TPDU (SMS-SUBMIT) as shown in FIG. 3b, at any time, independently of whether or not there is a speech or data call in progress. A report shall always be returned to the UE; either confirming that the SMS-SC has received the short message TPDU, or informing the UE that it was impossible to deliver the short message TPDU to the SMS-SC, including the reason why.

The SMS Point-to-Point (SMS-PP) may be implemented according to 3GPP TS 31.115, which provides the following descriptions for the implementation of SMS-PP.

### Structure of the UDH in a Secured Short Message Point to Point

The coding of the SMS-DELIVER, SMS-SUBMIT, SMS-DELIVER-REPORT header shall indicate that the data is binary (8 bit data), and not 7 bit or 16 bit. In order to invoke the UDH functionality of relevant SMS element, the UDHI bit shall be set as defined in TS 23.040.

However, in the case of a Response Packet originating from the UICC, due to the inability of the UICC to indicate to a ME that the UDHI bit should be set, the Response Packet SMS will not have the UDHI bit set, and the Sending Entity shall treat the Response Packet as if the UDHI bit was set.

The generalised structure of the UDH in the Short Message clement is contained in the User Data part of the Short Message clement and is described in TS 23.040. The Command Packet and the Response Packet are partially mapped into this UDH structure.

Information Element Identifiers (IEI's) values range ‘70-7F’ are reserved in TS 23.040 [3] for use in the present document and allocated as follows:
‘70’ and ‘71’ are specified in the present document
values ‘72-7D’ are reserved for future use
‘7E’ and ‘7F’ are for proprietary implementations.

If a Response Packet (Response Header+Data) is too large to be contained in a single Short Message (including the Response Header), it shall be concatenated according to TS 23.040.

If it is indicated in the SPI2 of a Command Packet to send back a PoR using SMS-DELIVER-REPORT and if the Response Packet is too large to be contained in a single SMS-DELIVER-REPORT-TP clement, then:
One single Response Packet shall be sent back to the SE using SMS-DELIVER-REPORT. This Response Packet:
Shall not contain any additional response data.
Shall contain the Response Status Code set to “Actual response data to be sent using SMS-SUBMIT”.
The security applied to this Response Packet shall follow the coding and rules as defined in ETSI TS 102 225.
This shall be followed by a complete Response Packet, contained in one SMS-SUBMIT element or in a concatenated Short Message composed of several SMS-SUBMIT elements.

### Structure of the Command Packet Contained in a Single Short Message Point to Point

CPI identifies the Command Packet and indicates that the first portion of the SM (8 bit data) contains the Command Packet Length (CPL), the Command Header Length (CHL) followed by the remainder of the Command Header: the Secured Data follows on immediately as the remainder of the SM element.

The relationship between the Command Packet and its inclusion in the UDH structure of a single Short Message defined in TS 23.040 is as following:
CPI is mapped to IEIa defined in TS 23.040 and shall be set to ‘70’.
IEDa defined in TS 23.040 shall be a null field and its length IEIDLa shall be set to ‘00’.

The following Table 1 indicates the Command Packet contained in a single SMS-PP. It is a particular implementation for single SMS-PP of the generic Command Packet structure described in ETSI TS 102 225.

TABLE 1
Structure of the Command Packet contained in the SM (8 bit data)

| Command Packet | | |
|---|---|---|
| Elements | Length | Description |
| Command Packet | 2 octets (see NOTE) | Length of the Command Packet (CPL), coded over 2 |
| Length | | octets, and shall not be coded as the length of BER- |
| | | TLV data objects described in ETSI TS 101 220. |
| Command Header | Null field | (CHI) Null field. |
| Identifier | | |
| Command Header | 1 octet | Length of the Command Header (CHL), coded over one |
| Length | | octet, and shall not be coded as the length of BER-TLV |
| | | data objects described in ETSI TS 101 220. |
| SPI to RC/CC/DS | Variable | The remainder of the Command Header as described in |
| in the Command | | ETSI TS 102 225. |
| Header | | |
| Secured Data | Variable | Application Message, including possible padding octets |
| | | as described in ETSI TS 102 225. |

It is recognised that most checksum algorithms require input data in modulo 8 length. In order to achieve a modulo 8 length of the data before the RC/CC/DS field in the Command Header the Length of the Command Packet and the Length of the Command Header shall be included in the calculation of RC/CC/DS if used. These fields shall not be ciphered.

When receiving a secured Command Packet requesting a Proof of Receipt (POR), the Receiving Entity shall follow the coding and rules as defined in ETSI TS 102 225. The Receiving Entity shall verify the authenticity of the Sending Entity. If the Receiving Entity cannot authenticate the Sending Entity, the Receiving Entity shall not send any Response Packet and discard the Command Packet with no further action being taken, as described in ETSI TS 102 225, clause 4.1.

The SPI shall be coded as specified in ETSI TS 102 225. The b6 of the second octet is used for SMS only and shall be coded as shown in FIG. 3c.

Through the service “data download via SMS Point-to-point”, the USIM (or UICC) may receive the short message and unpack the short message to obtain a secured packet included in the short message. The secured packet may be deciphered with UE specific application key. For example, data download to UICC may be implemented according to 3GPP TS 31.111, which provides the following descriptions for data download to UICC.

Data downloading to the UICC uses either dedicated commands (the transport mechanisms of SMS point-to-point and Cell Broadcast) or the Bearer independent protocol. Transferral of information over the UICC-ME interface uses the ENVELOPE command.

### SMS-PP Data Download Procedure

If the service “data download via SMS Point-to-point” is allocated and activated in the USIM Service Table (see TS 31.102), then the ME shall follow the procedure below:
when the ME receives a Short Message with:
protocol identifier=SIM data download; and
data coding scheme=class 2 message; or
when the ME receives a Short Message with:
protocol identifier=ANSI-136 R-DATA (see TS 23.040); and
data coding scheme=class 2 message, and the ME chooses not to handle the message (e.g. Mes not supporting EGPRS over TIA/EIA-136 do not need to handle the message).
then the ME shall pass the message transparently to the UICC using the ENVELOPE (SMS-PP DOWNLOAD) command as defined below:
the ME shall not display the message, or alert the user of a short message waiting:
the ME shall wait for an acknowledgement from the UICC;
When receiving a secured Command Packet (as specified in TS 31.115) requesting a Proof of Receipt (POR), the UICC shall verify the authenticity of the sender. If the authentication of the sender fails, no further processing related to the Proof of Receipt shall take place.
if the UICC responds with ‘90 00’ or ‘6F XX’ or ‘62 XX’ or ‘63 XX’, the ME shall acknowledge the receipt of the short message to the network using an RP-ACKmessage. The response data from the UICC will be supplied by the ME in the TP-User-Data element of the RP-ACK message it will send back to the network (see TS 23.040 and TS 24.011). The values of protocol identifier and data coding scheme in RP-ACK shall be as in the original message:
if the UICC responds with ‘93 00’, the ME shall either retry the command or send back an RP-ERROR message to the network with the TP-FCS value indicating ‘SIM Application Toolkit Busy’ (see TS 23.040).

If the service “data download via SMS-PP” is not available in the USIM Service Table, and the ME receives a Short Message with the protocol identifier=SIM data download and data coding scheme=class 2 message, then the ME shall store the message in EFSMS in accordance with TS 31.102.

### Procedure for SMS-PP Data Download Via REGISTRATION ACCEPT or DL NAS TRANSPORT Messages

If the service “data download via SMS Point-to-point” is allocated and activated in the USIM Service Table (see 3GPP TS 31.102), then the ME shall follow the procedure below:
when the ME receives a:
   REGISTRATION ACCEPT message or a DL NAS TRANSPORT message that includes an SOR transparent container information element with list type with value “0”=secure packet; or
   DL NAS TRANSPORT message that includes a UE parameters update transparent container containing a UE parameters update data set with UE parameters update data set type with value “1”=Routing Indicator update data
containing a secure packet constructed as an SMS-Deliver (as specified in 3GPP TS 23.040 with:
   protocol identifier=SIM data download; and
   data coding scheme=class 2 message
and the integrity check of the message was successful
then the ME shall pass the message transparently to the UICC using the ENVELOPE (SMS-PP DOWNLOAD) command as defined below:
the ME shall not display or alert the user
the secure packet is coded as a Command Packet formatted as Short Message Point to Point (as specified in 3GPP TS 31.115))

### Structure of ENVELOPE (SMS-PP DOWNLOAD)

Direction: ME to UICC.

The command header is specified in TS 31.101 [13].

Command parameters/data.

| Description | Clause | M/O/C | Min | Length |
|---|---|---|---|---|
| SMS-PP download tag | 9.1 | M | Y | 1 |
| Length (A + B + C + D + E) | — | M | Y | 1 or 2 |
| Device identities | 8.7 | M | Y | A |
| Address | 8.1 or 8.108 | C(see | N(see | B |
| | | note2) | note1) | |
| URI truncated | 8.135 | C | N | C |
| SMS TPDU | 8.13 | M | Y | D |
| (SMS-DELIVER) | | | | |
| Originating Address | 8.108 | C | N (see | E |
| | | | note1) | |

NOTE1:
The UICC shall be able to manage the situation when the address field is not present, in order to ensure backwards compatibility with previous releases of this specification.
NOTE2:
The address data object shall not be present when SMS-PP data download is transporting SOR transparent container information element received from REGISTRATION ACCEPT or DL NAS TRANSPORT message as such message does not contain the address of a service center.

Device identities: the ME shall set the device identities to:
   source: Network;
   destination: UICC.
Address: The address data object holds the RP_Originating_Address of the Service Centre (TS-Service-Centre-Address), as defined in 3GPP TS 24.011. If the USIM or the ISIM Service Table indicates URI support for SMS-PP DOWNLOAD, then this address data object may contain the Public Service Identity of the Service Center. If the URI is longer than the maximum length that can be transmitted to the UICC, then the URI shall be truncated to the maximum length that can be transmitted to the UICC and the request shall contain a URI truncated tag.

Originating Address: If the USIM or the ISIM Service Table indicates URI support for SMS-PP DOWNLOAD, then the Originating Address data object may be present and contain the Public Identity (IMPU) of the sender of the short message. If the URI is longer than the maximum length that can be transmitted to the UICC, then the Originating Address data object shall not be sent.
The secured packet is used to protect sensitive information, such as the preferred operator PLMN list. The secured packet may be created and retrieved according to 3GPP TS 29.544, for example. As specified in 3GPP TS 29.544, the secured packet application function (SP-AF) offers Nspaf_SecuredPacket Service via the Nspaf interface. The corresponding API defined for this service is summarized in the follow table.

TABLE 2
API Descriptions

| Service Name | Clause | Description | OpenAPI Specification File | apiName |
|---|---|---|---|---|
| Nspaf_SecuredPacket | 6.1 | Nspaf Secured Packet | TS29544_Nspaf_SecuredPacket.yaml | nspaf-secured- |
| | | Service | | packet |

The Nspaf_SecuredPacket Service may be consumed by the NF consumer (e.g. UDM or SOR-AF) when it has detected that a UICC configuration parameter (e.g. Routing ID data or Steering of Roaming information) needs to be updated, and the new value is not available in secured packet format.

For the Nspaf_SecuredPacket service the following service operation “Provide” are defined. The Nspaf_SecuredPacket Service is used by Consumer NFs (e.g. UDM or SoR-AF) to request the SP-AF to provide a secured packet that contains an UICC configuration parameter as sent in the request by means of the Provide service operation.

This service operation is used by the NF Service Consumer (e.g. UDM or SOR-AF) to request construction of a secured packet that contains the provided UICC configuration information (e.g. Routing Indicator or Steering of Roaming information). The procedure of “Secured Packet Retrieval” using the Provide service operation are supported.

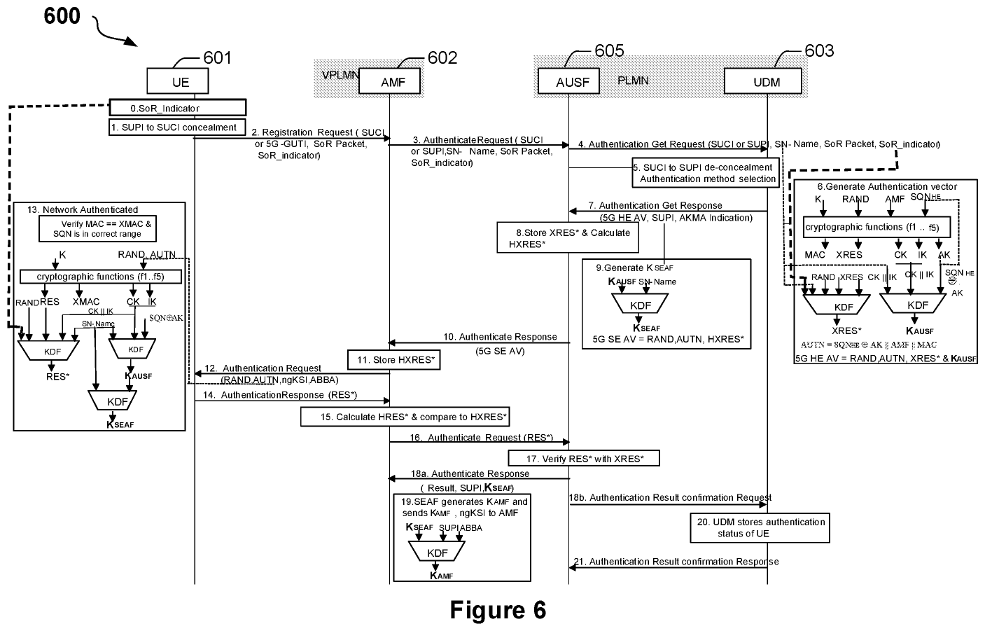

FIG. 4 shows a scenario where the NF consumer (e.g. UDM or SoR-AF) sends a request to the SP-AF to provide a secured packet. The request contains the UE's identity (/{supi}) and the UICC configuration parameter. 3GPP TS 29.544 provides the following descriptions for this procedure.
1. The NF consumer sends a POST request (custom method: provide-secured-packet) to the resource representing the SUPI.
2a. On success, the SP-AF responds with “200 OK”, containing the requested SecuredPacket.
2b. If the resource does not exist (the supi is unknown in the SP-AF), the SP-AF returns the HTTP status code “404 Not Found”, and additional error information should be included in the response body (in “Problem Details” element).
On failure, the appropriate HTTP status code indicating the error shall be returned and appropriate additional error information should be returned in the POST response body.

In the exemplary procedures of FIGS. 1 and 2, the SoR procedure is triggered by the HPLMN UDM. For example, the HPLMN UDM 103 would decide to send steering of roaming information to the roaming UE, as shown in step 3a in FIG. 1. In 5G network and future networks, a roaming UE would be capable to trigger a SoR procedure. For example, for a roaming UE activating a service/application requiring a network slice not offered by the serving network but available in the area from other network(s), the HPLMN shall be able to provide the UE with prioritization information of the VPLMNs with which the UE may register for the network slice. In order to help the HPLMN to provide information about slice availability per VPLMN to a UE, the UE would be required to securely indicate information (e.g., UE UPU/SoR capabilities, capability to handle Slice-Aware SoR information, UE location, Requested NSSAI, etc.) to its home network via visited network (e.g., a VPLMN). This provides a possibility that the UE can trigger VPLMN selection, e.g., by sending enhanced SoR information or indication (such as, UE UPU/SOR capabilities, its capability to handle Slice-Aware SoR information, UE location, Requested NSSAI, etc.) to the home network. For example, the UE is capable and configured to receive Slice-Aware SoR information. Then, the UE may indicate in a Registration Request that the UE shall receive Slice-aware SoR information, e.g., including VPLMN, location (e.g., geographical coordinates or specific TA) and S-NSSAI combination.

In a summary, there could be several kinds of slice aware/based SoR scenarios: a static SoR scenario, in which static SoR information would include default configured NSSAI which is preconfigured in UDM or SoR-AF and would not change; a partial dynamic SoR scenario, in which the SoR information may be dynamically changed based on a slice availability in specific TA of VPLMNs when a UE register to a VPLMN in the first time; and a dynamic SoR scenario, in which the SoR information may be dynamically changed when a UE registers to a VPLMN, or periodical registration update, or after subscription update.

In the static SoR scenario, subscribed S-NSSAIs are provisioned in a UDM, default configured NSSAI are provisioned in UE, supported S-NSSAIs which are supported by a VPLMN (probably in specific TAs) and mapping of S-NSSAIs between VPLMN and HPLMN are configured in NSSF, maybe also configured in AMF. The static SoR information is pre-configured in UDM or SoR-AF, and may be passed to UE during an initial registration (if the SoR update indicator is enabled), or after registration.

A list of VPLMNs may be prioritized based on S-NSSAIs supported by respective VPLMNs. For example, a list of VPLMNs with priority from high to low and respective corresponding supporting S-NSSAIs is as follows:
Priority P10: VPLMN with all subscribed S-NSSAIs are supported;
Priority P20: VPLMN with part of subscribed S-NSSAIs are supported;
Priority P30: VPLMN with no subscribed S-NSSAIs are supported.

In the partial dynamic SoR scenario, a UE registers to a VPLMN with default configured NSSAIs in requested NSSAIs, or without requested NSSAIs. NSSF/AMF of the VPLMN determines its configured NSSAI and corresponding mapping of its configured NSSAI to S-NSSAIs of HPLMN based on subscribed S-NSSAIs from HPLMN and local policies/configurations, then provisions its configured NSSAI and the corresponding mapping to the UE through a registration accept message. The requested NSSAI, and other information, such as location of a UE, may be sent from the UE the HPLMN in a SMC complete message after a primary authentication.

Then, the SoR information may be dynamically changed based on the slice availability in specific tracking area (TA) of VPLMNs, and a SoR procedure may be triggered accordingly based configured NSSAIs provisioned by respective VPLMNs in a specific country/area.

For example, a list of VPLMNs prioritized from a higher priority to a lower priority based on supporting S-NSSAIs of respective VPLMNs may arranged as follows:
Priority P02: all default configured S-NSSAIs (corresponding to subscribed S-NSSAIs) are supported by the VPLMN and available in the TA the UE camping on.
Priority PO5: all default configured S-NSSAIs (corresponding to subscribed S-NSSAIs) are supported by the VPLMN and part of them are available in the TA the UE camping on.
Priority P12: part of default configured S-NSSAIs (corresponding to subscribed S-NSSAIs) are supported by the VPLMN and available in the TA the UE camping on.

In a dynamic SoR scenario, a UE registers to a VPLMN after provisioned with VPLMN configured NSSAI, it could be initial register, or periodical registration update, or after subscription update, e.g., subscribed slices are changed.

The UE registers to a VPLMN with full or part of configured NSSAI (S-NSSAI of the VPLMN) and optional mapping to HPLMN in requested NSSAI. NSSF/AMF of the VPLMN determines allowed NSSAI based on TA, load of the slice and other policies. The requested NSSAI, and other information, such as location of UE, may be sent from the UE the HPLMN in a SMC complete message after a primary authentication.

The SoR information may be dynamically changed based on the slice load of the VPLMN (e.g., rejected as an admission control) or other policies. A SoR procedure may be triggered accordingly based on a registration result or other changes.

For example, a list of VPLMNs prioritized from a higher priority to a lower priority based on supporting S-NSSAIs of respective VPLMNs may arranged as follows:
Priority P00: all configured S-NSSAIs are available in the TA the UE camping on, and the slices are free.
Priority P03: all configured S-NSSAIs are available in the TA the UE camping on, and part of the slices are free.
Priority P12: part of configured S-NSSAIs is available in the TA the UE camping on, but all requested NSSAIs are available.
Priority P15: part of configured S-NSSAIs is available in the TA the UE camping on, and part of requested NSSAIs are available.
Priority P25: none of configured/requested S-NSSAIs is available in the TA.

A UE may trigger or initiate a dynamic or partial dynamic slice aware SoR procedure due to various conditions. In some scenarios, a UE may initiate a slice aware SoR procedure in an initial registration request based on its configuration. In some scenarios, a UE may initiate a slice aware SoR procedure when it detects that its expected or needed S-NSSAIs are not in the configured NSSAI of the serving PLMN (i.e., VPLMN) in the registration accept. In some scenarios, the UE may initiate a slice aware SoR when it detects that its expected or needed S-NSSAIs are in the rejected NSSAI in the registration response. The information sent by UE to trigger a SoR procedure may be referred to as “enhanced SoR related information” in this disclosure. The enhanced SoR related information may include the UE's UE parameter update (UPU) or SoR capabilities, the UE's capability to handle Slice-Aware SoR information, the UE's location, Requested NSSAI, probably list of available VPLMNs with respective configured NSSAIs and corresponding mappings to S-NSSAIs of HPLMN for each VPLMN, etc.

The 5G system shall secure procedures in support of HPLMN providing a roaming UE with information about slice availability and prioritization. Network-specific Steering of Roaming information sent to a UE has been integrity protected to prevent tampering from VPLMN as discussed above with reference to FIG. 2. The enhanced SoR related information provided by UE also needs to be integrity protected. If a roaming UE needs to transfer information to the HPLMN, the misbehaving AMF in a visited network may remove, modify or sniffer sensitive UE information sent from the UE to HPLMN. The HPLMN will not be able to provision the UE with prioritized VPLMN information if the serving network hides the information about rejected services or services could not be offered by the VPLMN. As such, the roaming UE shall be able to securely report to the HPLMN (when reporting is required), such that the VPLMN is not able to change the content of the report. The UE shall securely report to the HPLMN if a requested network slice is rejected by the VPLMN and if the UE needs to report to the HPLMN.

Security aspects on how to protect the enhanced SoR information provided by UE for triggering a SoR procedure (such as UE capabilities) are still in study. A new container (transparent for AMF) is being considered to be sent by included in a 5GC a roaming UE, containing information that is pertinent to activating the HPLMN service providing the UE with prioritization information of the VPLMNs with which the UE may register for the network slice.

While roaming, the UE includes a new transparent container in a 5GC Registration Request, when UE performs an initial registration or when the UE wants HPLMN to be aware of UE changes e.g. UE capability changes or UE requests new network slices. This new container is an indication that the UE wants the UDM to provide the UE with information relevant to subscribed/requested NSSAIs in the current VPLMN as well as other VPLMNs where the UE is currently located. The container includes the requested information and includes UE information that is pertinent to the request. The UE may send a protected container (transparent for AMF i.e. container is protected with home network security information) that includes info relevant for UDM e.g. UE capabilities, UE location, requested NSSAI, etc.

In some scenarios, the UE may send expected S-NSSAIs in a container. The AMF should transfer the container to the UDM and shall not change the context of the container, i.e., the AMF shall transfer the expected S-NSSAIs transparently. The expected S-NSSAIs are the S-NSSAIs in the Subscribed S-NSSAIs, thus UDM could understand the meaning of the expected S-NSSAIs. Then, the UDM would generate or retrieve from SoR-AF, SoR information based on the expected S-NSSAI. If there is no expected S-NSSAIs (e.g. for legacy UEs), the UDM or SoR-AF could generate SoR information based on the Subscribed S-NSSAI. In particular, the PLMNs supporting more Expected/Subscribed S-NSSAIs will have higher priority. The UDM should get the mapping between corresponding PLMNs and supporting S-NSSAIs based on configuration or from NSSF.

Moreover, upon reception of the Registration accept message, the UE sends a Registration complete message. The registration complete message contains secured assistance information e.g. rejected NSSAI and allowed NSSAI which is passed transparently to the UDM via AMF. The UE may also send secured assistance information in the UL NAS TRANSPORT message e.g., Registration complete message is not required to send.

Security aspects on protecting the container or information therein provided by the UE need to be considered and discussed. As mentioned in the background part, for some reasons, a visited network (e.g., VPLMN) may tamper information for a SoR procedure. For example, a misbehaving AMF in the VPLMN may alter, remove or sniffer the UE information transferred from a UE to its home network, hence blocking the SoR procedure. That causes the UE cannot access some network slices during roaming. As such, the UE may also need to securely send enhanced SoR-related information or indication (e.g., its capability, UE location, Requested NSSAI, etc.) to home network via the visited network. Furthermore, a UE may need to know whether the enhanced SoR-related information or indication is transferred successfully to its home network. If the UE detects that the VPLMN altered or removed the enhanced SoR-related information, then the UE may consider the current VPLMN as the lowest priority PLMN and perform PLMN selection.

Therefore, a security solution is required to protect integrity of the whole enhanced SoR-related information transferred by the UE and the confidentiality of sensitive elements in the enhanced SoR-related information, when the enhanced SoR-related information is transferred to the home network via the visited network. Furthermore, a security solution is required to avoid the whole enhanced SoR-related information being dropped or discarded, when the enhanced SoR-related information is transferred to the home network via the visited network. Furthermore, a security solution is required to enable a UE to be aware of whether the enhanced SoR-related information or indication is transferred successfully to its home network.

In some proposals, a UE-specific key K_{AUSF} was used for integrity and confidentiality protection of SoR information transferred from a UE to HPLMN. This proposal has many limitations. Firstly, a latest K_{AUSF} may not be available in an initial registration. As shown in FIG. 2, a UE does not store a new derived K_{AUSF} until receiving a NAS SMC message after a latest primary authentication. Thus, the enhanced SoR-related information or indication transferred before a primary authentication in an initial registration cannot be protected by using the K_{AUSF}. Secondly, the K_{AUSF} is traditionally used for integrity protection. It's not rational to use K_{AUSF} as key for both integrity protection and confidentiality protection. Thirdly, these solutions do not address the issue that the whole enhanced SoR-related information, including a SoR update request indicator, is dropped by the VPLMN without being aware by HPLMN. An acknowledge mechanism used in a HPLMN initialized SoR procedure (as shown in FIGS. 1 and 2) may not be valid for this UE initialized SoR procedure, as the HPLMN cannot even step in without recognizing the SoR update “intention” from the UE. So new mechanism is needed especially for this issue.

Embodiments of the present disclosure propose to protect the enhanced SoR-related information for triggering a SoR procedure, by virtue of a symmetric key which is available for the UE and its HPLMN before a primary authentication of an initial registration to a serving VPLMN.

In some embodiments, the symmetric key is an application key, which can be pre-configured in the UE (in its USIM) and a SoR-AF or be shared between the UE (in its USIM) and a SoR-AF, before the primary authentication. When it is determined that a SoR procedure is to be triggered, the USIM of the UE would send a secured packet to a ME of the UE as a MO SMS packet, for transferring the secured packet in an initial registration request message. The secured packet may be forwarded to the SoR-AF for fetching contents or information contained in the secured packet. Then, the fetched contents or information may be stored in a HPLMN UDM.

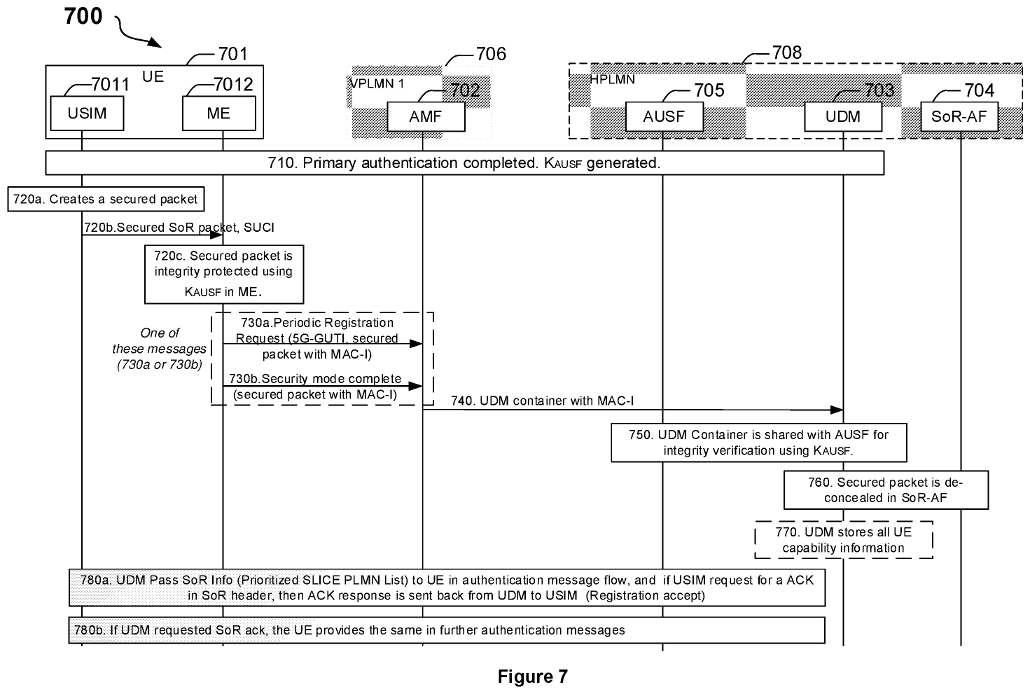

FIG. 5 is a flow diagram 500 illustrating an example procedure for protecting the enhancedSoR-related information by using an application key, according to an embodiment of the present disclosure.

The data flow diagram 500 includes a UE 501, an VPLMN AMF node 502, a UDM node 503, a SoR-AF node 504, and an AUSF node 505. The UE 501 may include an ME 5012 and a (removable) memory module (such as USIM) 5011. Although illustrated as USIM, the memory module may be a UICC. The UICC may include a Subscriber Identity Module (SIM), a Universal SIM (USIM), or a Removable User Identity Module (R-UIM) which are collectively known as UICC applications. The ME and the UICC may use a set of commands, USAT commands defined in 3GPP TS 31.111 to exchange data and request each other to perform operations on behalf of the other entity. In this disclosure, the terms USIM and UICC may be used interchangeable. The AMF node 502 is located in a first VPLMN 506 (VPLMN 1), which is serving a roaming UE 501. The UDM node 503, SoR-AF node 504, and AUSF node 505 are located in an HPLMN 508 of the UE 501.

At step 510, ME 5012 sends a SoR secured packet request to USIM 5011, to request the USIM 5011 to create a secured packet for enhanced SoR-related information. The SoR secured packet request comprise the sensitive information which need to be protected, such as UE capabilities (including UE UPU/SoR capabilities and capability to handle Slice-Aware SoR information, for example), UE location, requested NSSAIs, and any other SoR-relation information (e.g. for future extensions).

In some embodiments, configured NSSAIs of one or more other VPLMNs (denoted as VPLMN 2, which is different from the VPLMN 1) would also be sent to the USIM 5011. The configured NSSAIs indicate S-NSSAIs that are supported by respective other VPLMNs, and may be obtained by the ME 5012 during previous camping on these VPLMNs. Mappings of each S-NSSAI of the configured NSSAIs of respective VPLMNs to S-NSSAIs of HPLMN may also be sent to the USIM 5011, together with the configured NSSAIs. The configured NSSAIs may be utilized for determining a priority of VPLMNs, and thus may be a target to be tampered by a misbehaving AMF. Thus, it would be benefit to conceal the configured NSSAIs.

At step 520, in response to the SoR secured packet request, the USIM 5011 creates a secured packet as a MO SMS packet towards a network. The created secured packet contains the sensitive information, for example, including at least one of UE capabilities, UE location, requested NSSAIs, configured NSSAIs and mappings to S-NSSAIs of HPLMN. The sensitive information is ciphered with a first application key, and integrity protected with a second application key. The first and second application keys have been pre-configured in the USIM 5011 and a SoR-AF (such as SOR-AF 504) of the HPLMN.

At step 530, the USIM 5011 sends the secured packet to ME 5012 along with UE's SUCI (concealed SUPI).

At steps 540, 550 and 560, the UE 501 may initiate an initial registration procedure. In this regard, the ME 5012 may send an initial registration request with UE 501′s SUCI to the AMF 502. According to an embodiment of this disclosure, the secured packet for triggering a SoR procedure can be carried in the initial registration request to the AMF 502, and then forwarded to the AUSF 505 and the UDM 503. A serving network name (SN-name), e.g., an identity of the VPLMN 1 may be sent to the AUSF 505 and then to the UDM 503, as shown at steps 550 and 560.

At step 570a, the UDM 503 de-conceals the received SUCI to obtain the UE 501's SUPI, and selects an authentication method to perform a primary authentication for the UE 501. At step 570b, the UDM 503 sends the received secured packet and UE's SUPI towards the SoR-AF 504, e.g., by using a NSoraf_SoR_Get_Request service.

Then, at step 570c, the SoR-AF 504 verifies the secured packet (including check integrity of the secured packet and deciphers the secured packet), by using symmetric keys which are same as the first and second application keys respectively, and retrieves the enhanced SoR-related information which are contained into the secured packet by the USIM 5011 at step 520. In an embodiment, the SoR-AF 504 may provide slice-aware SoR information (such as, a list of preferred PLMNs and slice) according to the enhanced SoR-related information retrieved from the received secured packet. For example, a VPLMN which has more configured S-NSSAIs available to the UE may have a higher priority in the list. At step 570d, the SoR-AF 504 sends the received enhanced SoR-related information (which is provided from UE) and the retrieved SoR information (from SoR-AF) to the UDM 503.

At step 580, the UDM 503 may optionally store the whole or part of enhanced SoR-related information received from the SoR-AF 504, such as UE capabilities information (including UE UPU/SoR capabilities and capability to handle Slice-Aware SoR information, for example), configured NASSIs of one or more VPLMNs. The UDM 504 may utilize this information for further SoR procedure.

At step 590a, if SoR information that contains SoR slice-aware information (such as, a list of preferred PLMNs and slice) are available in the UDM 503, then the UDM 503 shall pass it to the UE 501. The SoR information may be obtained from the SoR-AF 504, or be determined by the UDM 503 based on the enhanced SoR-related information received from the SoR-AF 504. This SoR information may be protected by using the symmetric application keys maintained (or pre-configured or stored) in the SoF-AF 504. In an example, the SoF-AF 504 may create another secured packet by ciphering sensitive information with a symmetric application key of the first application key, and preforming integrity protection on the securted packet with the symmetric application key of the second application key. The SoF information sent from the SoF-AF 504 to the UDM 503 and then passed to the UE 501 may contain said another secured packet. Correspondingly, the UE 501 may verify the secured packet received from the HPLMN 508, for example, by checking integrity of the received secured packet by using the second application key and decipher the secured packet received from the HPLMN 508 by using the first application key, e.g., at step 590b.

In an embodiment, the USIM 5011 or ME 5012 requests for an ACK for detecting whether the secured packet is successfully received by the home network. For example, an ACK indication may be included in the initial registration request by the ME 5012 at step 540, and delivered to the UDM 503. In response to a reception of the ACK indication, the UDM 503 may send an ACK (e.g., in a header of the SoR information) to the UE 501, at step 590a. When the UE 501 (by ME 5012) gets the ACK, the UE 501 may determine that the received SoR information is triggered by the UE 501. It means that the secured packet is successfully received by the home network.

At step 590b, if it is determined that the UDM 503 requests an ACK from UE for the provision of SoR information (e.g., at step 590a), then the UE 501 may provide a SoR ACK to the UDM 503 in a further authentication message. This further authentication may be performed in a same way as that shown in steps 13 to 15 of FIG. 2.

Then, based on the SoR information received at the UE 501, the UE 501 may reselect a VPLMN if the serving PLMN (VPLMN 1) is not in the priority list of preferred PLMNs and slice.

In the procedure shown in FIG. 5, the secured packet containing the protected enhanced SoR-related information is sent from the AMF 502 to the UDM 503 before a completion of a primary authentication of the UE, e.g., via an authentication message such as the Nausf_UEAuthenticate Request. In an alternative embodiment, this secured packet may be sent from the AMF 502 to the UDM 503 after a successful completion of a primary authentication of the UE, e.g., in a UDM registration message such as a Nudm_UECM_Registration message.

Some embodiments further take countermeasures for possible scenarios where a VPLMN AMF drops a SoR secured packet transferred from a UE to its HPLMN. In an embodiment, if the VPLMN AMF 502 has dropped the SoR secured packet from the UE 501, the initial registration response would not comprise the SoR secured packet. Then, no corresponding ACK would be sent back to the UE 501, and the UE 501 may be able to determine that the SoR secured packet is not successfully transferred. Then, this VPLMN 206 can be marked as suspicious in the UE 501. Furthermore, the UE 501 could trigger a camping on another VPLMN or visited network with a different access (for example, Non-3GPP access). In another access, the SoR secured packet may be sent by UE to HPLMN.

In another embodiment, the UE 501 may include a new indicator (e.g., a “SoR indication” bit set to “True”) into the initial registration request, at step 540. This bit is used in a calculation of “XRES*” in the UDM 503 and in a calculation of “RES*” in the UE 501, e.g., during an AKA challenge.

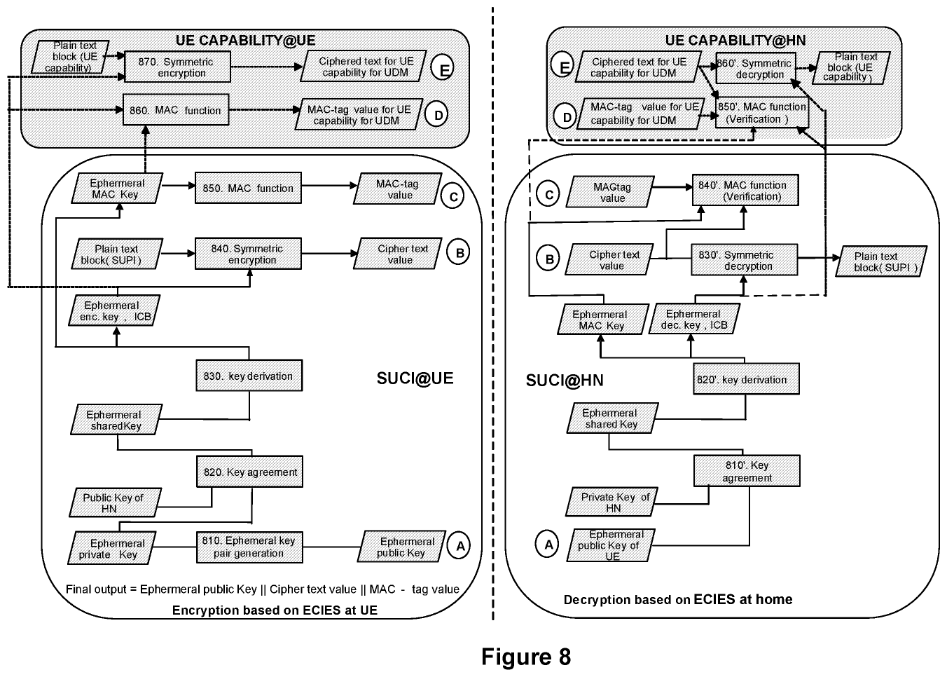

FIG. 6 is a flow diagram illustrating an example procedure for utilizing the new indicator in an AKA challenge to detect if enhanced SoR-related information triggered by USIM/UE is dropped by a serving VPLMN during a primary authentication. The UE 601, AMF 602, AUSF 605 and UDM 603 may be corresponding same entities as the UE 501, AMF 502, AUSF 505 and UDM 503 of FIG. 5. As shown in FIG. 6, a SoR indicator is configured or set in UE 601 (e.g., in ME of the UE) at step 0. This SoR indicator may be delivered to the UDM 603 through steps 2, 3 and 4, and then utilized in a calculation of “XRES*” in the UDM 603 at step 6. This SoR indicator may be utilized in a calculation of “RES*” in the UE 601 (i.e., in USIM of the UE), at step 13, for network authentication. Then, through verifying whether “XRES*” equals to “RES*” or not at step 17, a dropping of the SoR indicator with SoR secured packet transferred together with the SoR indicator may be detected.

In case the AMF 602 dropped the SoR packet and SoR indicator bit, then the RES* calculation and XRES* calculation will be different, and so the verification at step 17 fails. This results in a failure of the primary authentication, and will be aware by both HPLMN (such as the UDM 603). This result would also be informed or sent to the UE 601. Then, the UE 601 may know that the enhanced SoR-related information may be dropped by the VPLMN, and response with some further operations, such as selecting a different VPLMN. The HPLMN may report the issue as well.

In some embodiments, a secured packet for triggering a SoR procedure is sent from a USIM of a UE to a ME of the UE as a MO SMS packet after an initial registration procedure. This means, the UE-specific key K_{AUSF} can be used for integrity protection of the secured packet, e.g., for MAC-I generation of the secured packet. The secured packet may be ciphered by using an application key as the embodiment shown in FIG. 5, and sent to a SoR AF for fetching contents or information contained in the secured packet. MAC-I is verified by K_{AUSF}.

The described procedure illustrated in FIG. 5 uses two different application keys which can be preconfigured in the UE side (in USIM) and HPLMN side (e.g., in a SoR-AF), to respectively protect the confidentiality and integity of the enhanced SoR-related information provided by the UE to the HPLMN. It should be appreciated that it is also applicable to utilize only one application key or more than one application keys which may be pre-configured in the UE side (in USIM) and HPLMN side (e.g., in a SoR-AF), to protect the enhanced SoR-related information provided by the UE to the HPLMN, and optionally protect the SoR information provided from the HPLMN to the UE in a similar way. An application keys may be pre-configured to provide integrity protection for the enhanced SoR-related information, and the SoR information. This security mechanism enables the roaming UE to trigger a SoR procedure at the earliest convenience, e.g., before the primary authentication being successfully completed.

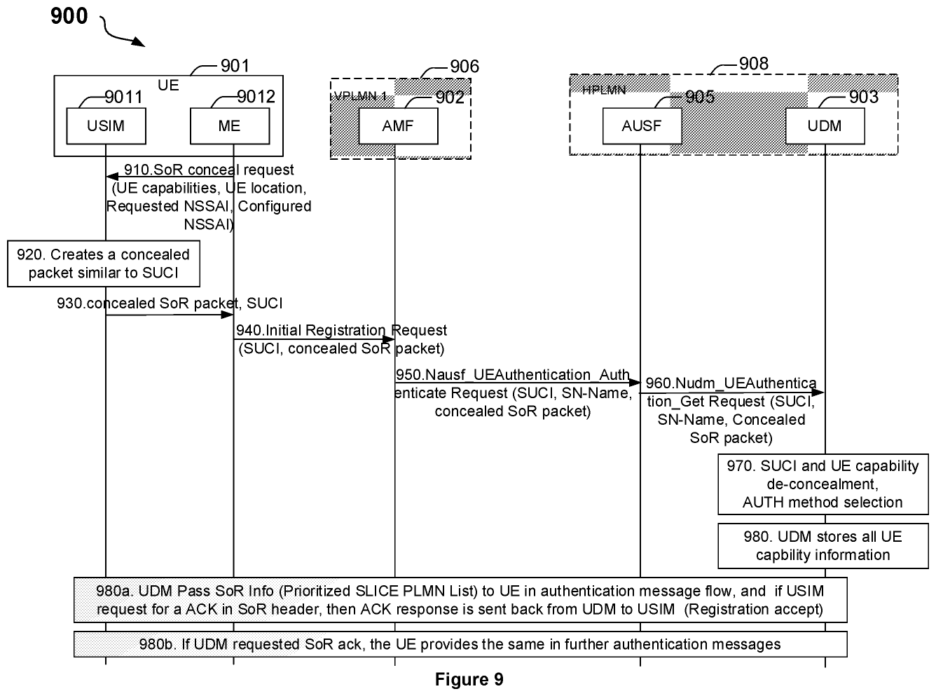

FIG. 7 is a flow diagram 700 illustrating an example procedure for protecting the enhanced SoR-related information by using an application key after a primary authentication (e.g., after an initial registration, or during an initial registration), according to an embodiment of the present disclosure. The data flow diagram 700 includes a UE 701 having a USIM 7011 and a ME 7012, an AMF node 702, a UDM node 703, a SoR-AF node 704, and an AUSF node 705, which may be deployed in the network in a similar way as the corresponding entities or nodes in FIG. 5.

At step 710, a primary authentication between the UE 701 and its HPLMN is completed successfully. Then, UE-specific key K_{AUSF} is generated at the UE 701 (e.g., in USIM 7011 or in ME 7012), and at the HPLMN side (e.g., in the AUSF 705).

At step 720a, the USIM 7011 in the UE 701 creates a secured packet, for example, due to various reasons, such as a UE location change, capability change or slice change, etc. The creation may be performed in a similar way as that of step 520 illustrated in FIG. 5. In this regard, the created secured packet contains sensitive information seek to be protected by the UE 701, for example including at least one of UE capabilities, UE location, requested NSSAIs, configured NSSAIs and mappings to S-NSSAIs of HPLMN. The sensitive information is ciphered with an application key, which has been pre-configured in the USIM 7011 and a SoR-AF (such as SoR-AF 704) of the HPLMN.

At step 720b, the USIM 7011 sends the secured packet to ME 7012 along with UE's SUCI (concealed SUPI).

At step 720c, the secured packet may be integrity protected by using K_{AUSF} in the ME 7012.

At step 730a, a periodic registration request with 5G-GUTI, the secured packet and the MAC-I generated from the integrity protection of the secured packet, is sent to the AMF 702. Alternatively, a service request containing the secured packet and the MAC-I can be sent by the UE 701 to the AMF 702, as shown at step 730b.

At step 740, this secured packet is forwarded to the UDM 703 along with the MAC-I. The secured packet may be also called as UDM container.

At step 750, the UDM 703 sends the received UDM container (i.e., the secured packet) to the AUSF 705, as it holds the K_{AUSF} key. The AUSF 705 checks the integrity of the received packet.

At step 760, after the integrity check is successful, the secured packet is sent to the SoR-AF 704 for a deciphering or de-concealment of the secured packet to get the enhanced SoR-related information. Then, the enhanced SoR-related information in the secured packet is shared back from the SoR-AF 704 to the UDM 703. This step may be performed in a similar way as steps 570b, 570c and 570d of FIG. 5.

Similar as step 580 of FIG. 5, the UDM 703 may optionally store at step 770, the whole or part of enhanced SoR-related information received from the SoR-AF 704, such as UE capabilities information (including UE UPU/SoR capabilities and capability to handle Slice-Aware SoR information, for example), configured NASSIs of one or more VPLMNs.

Then, steps 780a, and 780b may be implemented in a similar way as steps 590a and 590b of FIG. 5.

The described procedure illustrated in FIG. 7 use two different keys to provide confidentiality protection and integrity protection, separately. This security mechanism enables a SoR procedure triggered by a roaming UE to be protected more effectively.

In some alternative embodiments, the symmetric key generated from asymmetric key pairs for SUCI generation may be re-used for protecting the confidentiality of the enhanced SoR-related information. At UE side, symmetric key generated from asymmetric key pairs for SUCI generation is re-used for encryption of enhanced SoR-related information (such as UE capabilities) needed to be concealed into the secured packet. Similarly ephemeral MAC key can be used to generate MAC-I of the secured packet. During de-concealment of the UE's SUCI, the symmetric key generated from asymmetric key pairs is re-used for decryption of the secured packet. MAC-I is also checked by using a MAC function. In this regard, an approach similar as that of UE may be performed at the UDM to fetch the enhanced SoR-related information (such as UE capability content) and stored in the UDM.

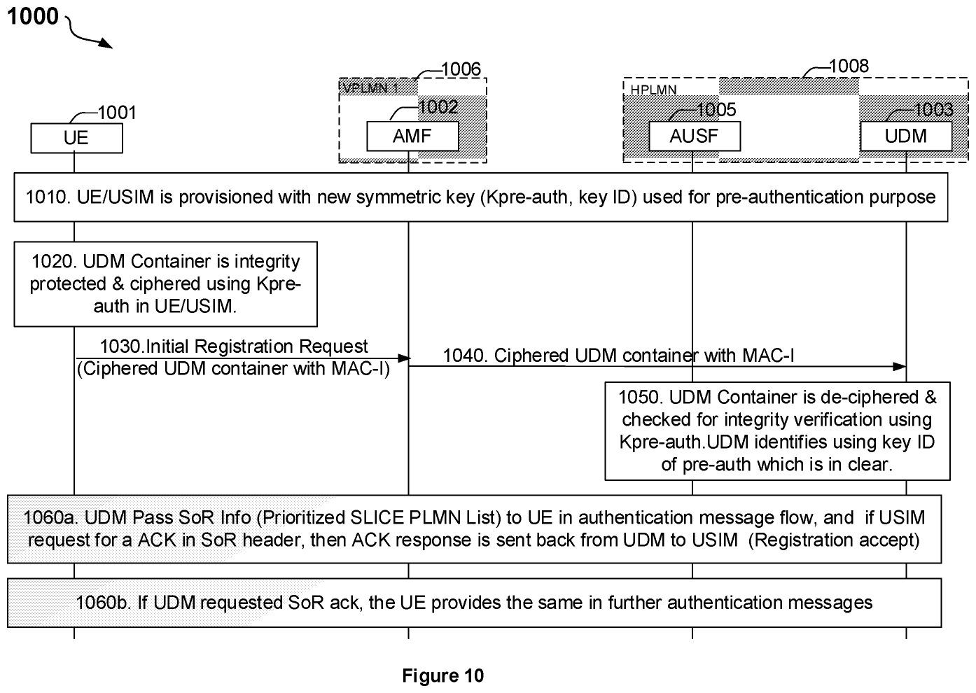

FIG. 8 is a flow diagram illustrating an example process for generating these symmetric keys by reusing SUCI generation mechanism. Below is brief descriptions for SUCI generation (at a UE) and verification (e.g., at SIDF of a UDM) procedures.

At a UE (shown in the left part of FIG. 8), an ephemeral key pair (including an ephemeral public key and a private key) is generated by using key pair generation primitive, as shown at block 810. Based on the Diffie-Hellman primitive, a shared secret key element is derived (from public key of HN and generated ephemeral private key), as shown at block 820. Followed by that, key derivative function KDF is used to generate keying data K of length Encryption Key EK+Initial counter block ICB+MAC key, as shown at block 830. With the derived keys EK and ICB, symmetric encryption is performed to encrypt the plaintext block (SUPI) to generate the ciphered text, as shown at block 840. Then, a tagging operation of the MAC scheme is used to compute a tag for the ciphered text (of SUPI) by using the generated MAC key, as shown at block 850.

According to embodiments of this disclosure, a tagging operation of the MAC scheme may be used to compute a tag for the ciphered text (of enhanced SoR-related information, such as UE capabilities, for providing to a UDM) by also using the generated MAC key, as shown at block 860. Furthermore, as shown at block 870, with the derived keys EK and ICB, symmetric encryption is performed to encrypt the plaintext block (of enhanced SoR-related information, such as UE capabilities for providing to the UDM), to generate the ciphered text (of enhanced SoR-related information, such as UE capabilities, for providing to a UDM). The enhanced SoR-related information is concealed in the ciphered text, and the VPLMN may not even be aware that the concealed information is for SoR.

At the home network, e.g., in a UDM (shown in the right part of FIG. 8), an ephemeral public key received from the UE and a private key of home network is used to generate the ephemeral shared key, as shown at block 810′. With the key derivative functions, keying data K of length decryption Key DK+Initial counter block ICB+MAC key is generated, as shown at step block'. The generated DK and ICB is used to de-cipher the ciphered text (of SUPI) using symmetric decryption, as shown at block 830′. Ephemeral MAC keys are used on ciphered text to generate the expected MAC, which is compared against the received MAC, and with this comparison the integrity of the SUCI is verified, as shown at block 840′.

According to embodiments of this disclosure, as shown at block 850′, ephemeral MAC keys can also be used on ciphered text (of enhanced SoR-related information, such as UE capabilities, for providing to a UDM) which is received from the UE, so as to generate an expected MAC, which is compared against the received MAC from the UE, and then with this comparison the integrity of the enhanced SoR-related information provided for UDM can be verified at the UDM. Furthermore, as shown at block 860′, the generated DK and ICB can also be used at the UDM to decipher the ciphered text (of enhanced SoR-related information, such as UE capabilities, for providing to a UDM) by using a symmetric decryption corresponding to the block 870.

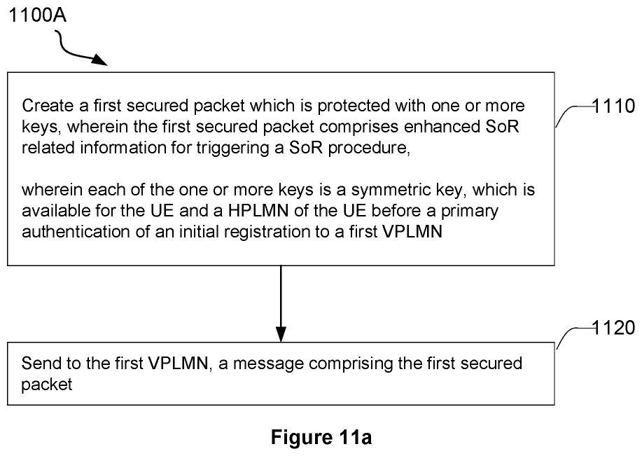

FIG. 9 is a flow diagram illustrating an exemplary SoR procedure for protecting the enhanced SoR-related information by reusing symmetric keys generated in FIG. 8, according to an embodiment of the present disclosure. The data flow diagram 900 includes a UE 901 having a USIM 9011 and a ME 9012, a VPLMN AMF node 902, a UDM node 903, and an AUSF node 905, which may be deployed in the network in a similar way as the corresponding entities or nodes in FIG. 5.

At step 910, the ME 9012 sends a SoR concealed packet request with sensitive enhanced SoR-related information (such as, information elements IEs, e.g., configured NSSAIs of VPLMNs and corresponding mappings, optionally UE capabilities, UE location and requested NSSAIs) to the USIM 9011.

At step 920, the USIM 9011 creates a concealed packet in a manner similar as the concealment for SUCI, as shown in FIG. 8. The concealed packet contain the sensitive enhanced SoR-related information may comprise configured NSSAIs of VPLMNs and corresponding mappings, and optionally UE capabilities, UE location and requested NSSAIs, and any other information needed to be protected. The USIM 9011 may further perform integrity protection to the sensitive enhanced SoR-related information or the concealed packet, in the way shown in FIG. 8.

At step 930, the USIM 9011 sends the concealed packet to the ME 9012 along with the SUCI (i.e., concealed SUPI).

The ME 9012 would send an initial registration request with the UE's SUCI and concealed SoR packet to the AMF 902, then to the AUSF 905 and the UDM 903, as shown at steps 940, 950 and 960.

At step 970, the UDM 903 de-conceals the received SUCI, and de-conceals the concealed SoR packet in a similar way as that de-concealment for SUCI, as shown in FIG. 8. Then, the UDM 903 may select an authentication method. In case that an integrity protection is performed, the UDM 903 may further check the integrity of the concealed SoR packet, in a similar way as that for integrity verification of SUCI. The concealment may be performed after the integrity verification is completed successfully. Accordingly, the sensitive enhanced SoR-related information can be retrieved from the concealed packet, and then be used to trigger a SoR procedure.

At step 980, the UDM 903 may store a part or the whole of the de-concealed enhanced SoR-related information, such as UE capabilities information (including UE UPU/SoR capabilities and capability to handle Slice-Aware SoR information, for example), UE location and requested NSSAI, configured NASSIs of one or more VPLMNs, and any other SoR information (e.g., for future extensions).

Then, steps 980a, and 980b may be implemented in a similar way as steps 590a and 590b of FIG. 5.

Similar as the security mechanism described with reference to FIG. 5, the procedure of FIGS. 8 and 9 uses symmetric keys which can be derived/generated in the UE side (in USIM) and HPLMN side (e.g., in a UDM), to protect the confidentiality and integrity of the enhanced SoR-related information provided by the UE to the HPLMN. This security mechanism also enables the roaming UE to trigger a SoR procedure at the earliest convenience, e.g., before the primary authentication being successfully completed. It should be appreciated that one or more symmetric keys may be derived/generated in the UE side (in USIM) and HPLMN side (e.g., in a UDM), to protect the enhanced SoR-related information provided by the UE to the HPLMN, and optionally protect the SoR information provided from the HPLMN to the UE, in a similar way. For example, another different symmetric key may be generated and used to provide integrity protection for the enhanced SoR-related information and the SoR information.

In the embodiment illustrated in FIG. 8, the same intermediate keys (i.e., keys derived at steps 830 and 830′) are used to derive the symmetric key for confidentiality protection (i.e., the ephermeral key inputted into block 870, and the ephermeral key inputed into block 860′) and the symmetric key for confidentiality protection (i.e., the ephermeral key inputed into block 860, and the ephermeral key inputted into block 850′). In other embodiments, different intermediate keys which are derived from the asymmetric key pairs for SUCI generation, may be used to generate the symmetric key for confidentiality protection and the symmetric key for confidentiality protection separately.

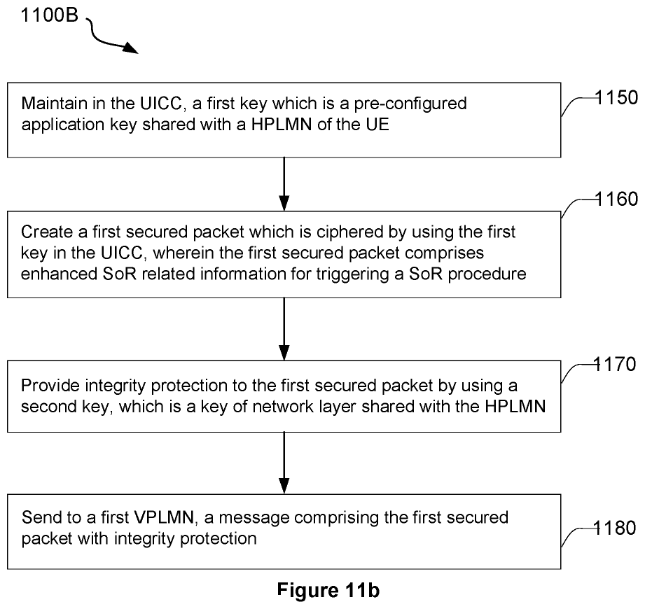

In some alternative embodiments, a symmetric key of data link layer pre-configured at a UE and its home network (e.g., at a UDM or AUSF) may be utilized for protecting the confidentiality and/or integrity of the enhanced SoR-related information. FIG. 10 is a flow diagram illustrating an example procedure for protecting information for triggering a SoR procedure by using a key of network layer, according to an embodiment of the present disclosure. The data flow diagram 1000 includes a UE 1001 having a USIM (not shown) and a ME (not shown), an AMF node 1002, a UDM node 1003, and an AUSF node 1005, which may be deployed in the network in a similar way as the corresponding entities or nodes in FIG. 5.

At step 1010 in the data flow diagram 1000, the UE (e.g., the ME or the USIM of the UE) is provisioned or pre-configured with a new symmetric key (for example, referred to as Kpre-auth) with a Key ID (identity), which may be used for pre-authentication purposes. Meanwhile, the new symmetric key (i.e., Kpre-auth, together with its Key ID) is also provisioned to an authentication entity (such as the UDM 1003 or the AUSF 1005) at the home network. This new symmetric key may be a key of network layer which is pre-configured at the UE and the home network before a primary authentication of the UE. For example, the Kpre-auth may be issued and written into the USIM of the UE by an operator when the USIM is issued to a user of the UE. In another example, the Kpre-auth may be generated at the UDM and issued to the UE (i.e., to a ME of the UE), when the UE is being served by the HPLMN.

As step 1020, a UDM container (i.e., a secured packet to be provided to UDM) may be ciphered by using Kpre-auth in the UE 1001 (in a USIM or ME of the UE). The secured packet contains sensitive enhanced SoR-related information for triggering a SoR procedure, such as UE capabilities information (including UE UPU/SoR capabilities and capability to handle Slice-Aware SoR information, for example), configured NSSAIs of one or more VPLMNs.

In some embodiments, another new symmetric key (for example, referred to as K'pre-auth) with a Key ID′ may be pre-configured at the UE 1001 and the UDM 1003 for integrity protected. In this regard, the UDM container may be integrity protected by using K'pre-auth in the UE 1001 (in a USIM or ME of the UE), at step 1020. For example, a tag MAC-I may be calculated based the ciphered UDM container and the key K'pre-auth.

As shown in steps 1030 and 1040, the ciphered UDM container is sent (with MAC-I, if any) to the UDM 1003.

At step 1050, the ciphered UDM container is de-ciphered by using the key Kpre-auth, and the integrity is checked by using the key K'pre-auth. The deciphering and integrity verification may be performed at the UDM 1003 or the AUSF 1005, dependent on which one maintains (or stores) the pre-configured keys Kpre-auth and K'pre-auth. In case that these keys are maintained in the UDM 1003, the UDM 1003 may identify these keys by using corresponding key IDs, which may be sent from the UE to the UDM 1003 in plaintext. In case that these keys are maintained in the AUSF 1005, the UDM 1003 may forward the received ciphered UDM container to the AUSF 1005, together with the corresponding key IDs, so as to trigger verification of the ciphered UDM container. The AUSF 1005 would identify the keys Kpre-auth and K'pre-auth by using the received key IDs, so as to perform the deciphering and integrity verification on the ciphered UDM container. Then, the AUSF 1005 transfers the enhanced SoR-related information retrieved from the UDM container to the UDM 1003.

According to the enhanced SoR-related information, the UDM 1003 may decide to send SoR information to the UE 1001. For example, a list of preferred PLMNs and slices may be determined based on the enhanced SoR-related information. Then, steps 1060a and 1060b may be implemented in a similar way as steps 590a and 590b of FIG. 5. These keys may be also utilized to protect the SoR information provided from the UDM 1003 to the UE 1001.

It should be appreciated that the features of using an ACK indication for avoiding or detecting a VPLMN AMF dropping the SoR secured packet as described above with reference to FIG. 5 are also applicable to the other embodiments in this disclosure, such as the data flows 700, 900 and 1000 of FIGS. 7, 9, and 10. In this regard, an ACK indication may be included in a message together with the secured packet or container sent from the UE to its home network, for request an ACK response from the home network.

It should be appreciated that the features of using a SoR indicator for avoiding or detecting a VPLMN AMF dropping the SoR secured packet as described above with reference to FIG. 5 are also applicable to the other embodiments in this disclosure, such the data flows 900 and 1000 of FIGS. 9 and 10. The SoR indicator may be included in an initial registration message together with the secured packet or container, for the calculation of RES* and XRES* in a primary authentication.

Similar as the security mechanisms described with reference to FIGS. 5, 8 and 9, the procedure of FIG. 10 uses symmetric keys of network layer which can be pre-configured in the UE side (in USIM) and HPLMN side (e.g., in a UDM), to protect the confidentiality and integrity of the enhanced SoR-related information provided by the UE to the HPLMN. This security mechanism also enables the roaming UE to trigger a SoR procedure at the earliest convenience, e.g., before the primary authentication being successfully completed.

It should be appreciated that the one or more symmetric keys which are pre-configured, derived, or generated in a UE side (in USIM) and HPLMN side (e.g., in a UDM) before a primary authentication of the UE, may be utilized to protect the SoR procedure during the primary authentication or after the primary authentication.

It should be appreciated that while the methods, devices, and computer program products described herein are described within the context of a fifth-generation (5G) core network and system, such as illustrated in FIGS. 1-10 and described hereinabove, the described methods, devices, and computer program products can nevertheless be applied in a broader context within any suitable telecommunications system, network, standard, or protocol.

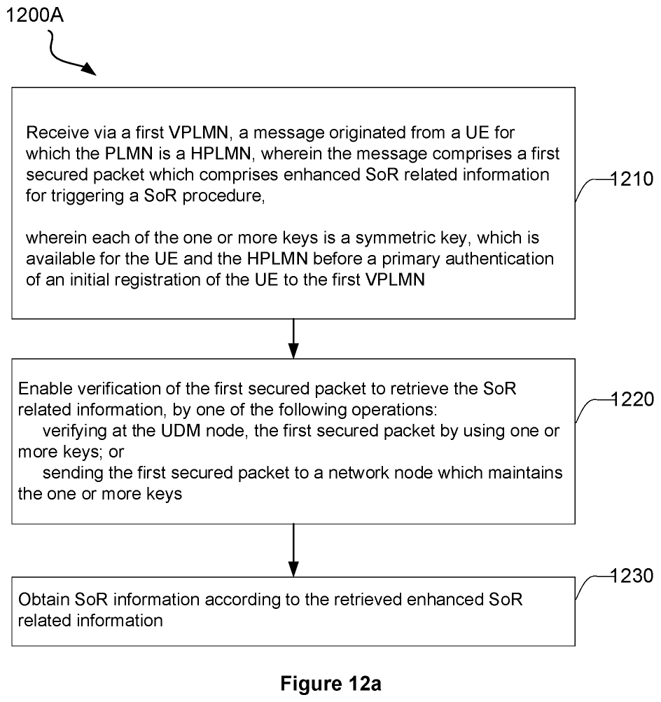

More details of the example embodiments in accordance with the present disclosure will be described with reference to FIGS. 11a, 11b, 12a, 12b, 13 and 15. FIG. 11a illustrates a flowchart of a method 1100A according to an embodiment of the present disclosure. The method 1100A can be implemented at any suitable device. For example, the method 1100A can be implemented at a UE, which is configured to implement the UE 501, UE 601, UE 901 and UE 1001.

As shown at block 1110, a method 1100A comprises creating a first secured packet which is protected with one or more keys. The first secured packet comprises SoR information for triggering a SoR procedure. As shown at block 1120, a method 1100A comprises send to a first VPLMN, a message comprising the first secured packet. The first VPLMN is a serving network.

For example, the enhanced SoR related information for triggering the SoR may comprise at least one of the following: configured network slice selection assistance information (NSSAI) of a second VPLMN; corresponding mappings of one or more single NSSIAs (S-NSSAI) of the configured NSSAI to respective S-NSSAIs of a HPLMN of the UE; at least one capability of the UE; a location of the UE; or NSSAI requested by the UE. The second VPLMN may be a visited network different from the first VPLMN.

According to embodiments of this disclosure, each of the one or more keys is a symmetric key, which is available for the UE and its HPLMN before a primary authentication of an initial registration to the first VPLMN. In an embodiment, the one or more keys may comprise a first key for confidentiality protection. Then, the method 1100A may further comprise ciphering the enhancedSoR related information by using the first key, so as to create the first secured packet. Alternatively or additionally, the one or more keys may comprise a second key for integrity protection. Then, the method 1100A may further comprise providing integrity protection for the enhanced SoR related information by using the second key. For example, a message authentication code (such as MAC-I) may be calculated based on the first secured packet and the second key.

In some embodiments, the message may be sent to an AMF of the first VPLMN in an initial registration procedure. In this regard, the message may be an initial registration message.

In some embodiments, the method may further comprise sending from a ME of the UE to a UICC (such as a USIM) of the UE, a request for creating the first secured packet. The request comprises the enhanced SoR related information for triggering the SoR procedure. Then, the UE may perform a security protection for the enhanced SoR related information by using the one or more keys in the UICC, so as to create the first secured packet.

In some embodiments, the one or more keys may be pre-configured application keys, which are shared in the UICC of the UE and its HPLMN (e.g., the SOF-AF 504) before a primary authentication of an initial registration to the first VPLMN. The secured packet is generated at an “application” layer (e.g., an application layer according to the OSI reference model, or 3GPP standards). In an example, these application keys may be downloaded into the UICC through a “data download via SMS Point-to-Point” service, when the UE is in the HPLMN. In another example, these application keys may be written into the UICC when a user of the UE become a subscriber of an operator of the HPLMN and get the UICC. Then, the UICC would maintain (or store) these keys for a SoR application. The UICC may maintain (or store) two different application keys for the SoR application. One is an application key for providing confidentiality protection, and the other is for providing integrity protection. Then, both the confidentiality protection and integrity protection may be performed for the first secured packet in the UICC.

In some embodiments, the one or more keys may be generated in the UICC from asymmetric key pairs used for a SUCI generation, e.g., as shown in FIG. 8. Accordingly, the secured packet would be generated at the “network” layer (e.g., a network layer according to the OSI reference model, or 3GPP standards). The UICC may generate two keys for protect the first secured packet at a “network” layer, one for integrity protection, and another for confidentiality protection. These keys are shared in a UICC of the UE and its HPLMN (such as, the UDM 903).

In some embodiments, the one or more keys may be pre-configured keys of network layer. These keys of network layer may be pre-configured in the UICC or ME of the UE and its HPLMN (e.g., the UDM 903 or the AUSF 905) before a primary authentication of an initial registration to the first VPLMN. For example, these keys may be shared in the UE and the HPLMN when the UE is in the HPLMN and does not roaming into the first VPLMN. The one or more keys may comprise two keys for protect the first secured packet at a “network” layer, one for integrity protection, and another for confidentiality protection. In an embodiment, these pre-configured keys of network layer are identified with respective key ID. For example, there may be several set of such keys pre-configured for a specific UE, for different usage cases. The UE may send at least one key identity of at least one key of the one or more keys to the HPLMN, e.g., together with the first secured key in the message, so as to indicate the HPLMN which keys are used to protect the first secured packet.

In some embodiments, the method 1100A may further comprise receiving SoR information from the HPLMN via the first VPLMN. The SoR information may comprise a second secured packet which is protected with one or more symmetric keys of the one or more keys. Then, the method 1100A may further comprise verifying the second secured packet by using the one or more keys. In this regard, the one or more symmetric keys are the corresponding keys maintained (or stored, generated, or pre-configured) in the HPLMN (e.g., in a SoR-AF, a UDM, or an AUSF). For example, the second secured packet may be integrity protected with a symmetric key (referred to as a fourth key) corresponding to the second key by the HPLMN. Then, the UE may check the integrity of the received second secured packet by using the second key. Alternatively, the second secured packet may be ciphered with a symmetric key (referred to as a third key) corresponding to the first key by the HPLMN. Then, the UE may decipher the received second secured packet by using the first key.

In some embodiments, the method 1100A may further comprise setting an ACK indication in the message to indicate that the UE needs an acknowledgement of a receipt of the first secured packet from the HPLMN; and determining whether the first secured packet is sent successfully according to an ACK response for the first secured packet, which is to be received from the HPLMN. The UE may determine whether SoR information received from the HPLMN via the first VPLMN comprises the ACK response for the first secured packet. In one scenario, the SoR information received from the HPLMN does not comprise any ACK response, it may be determined the SoR information is not triggered by the first secured packet. For example, the SoR information may be triggered by the HPLMN side (e.g., triggered by a UDM when it detects an update of a list of preferred PLMNs). In another scenario, the UE may even receive no SoR information. In either scenario, the UE may determine that the first secured packet is not sent successfully. Then, the UE may perform perform at least one of the following operations: marking the first VPLMN as a suspicious VPLMN; triggering a camping on another VPLMN; or sending the first secured packet for triggering the SoR procedure to the HPLMN, via another network. Said another network may connect the UE with the HPLMN via different access technologies, such as via a WLAN connection, a Wifi connection or even via a wire connection.

FIG. 11b is a flowchart of a method 1100B according to an embodiment of the present disclosure. The method 1100B can be implemented at any suitable device. For example, the method 1100B can be implemented at a UE, which is configured to implement the UE 701 as shown in FIG. 7.

As shown at block 1150, a method 1100B comprises maintaining in a UICC of the UE, a first key which is a pre-configured application key shared with a HPLMN of the UE. At block 1160, the method 1100B comprises creating a first secured packet which is ciphered by using the first key in the UICC. The first secured packet comprises enhanced SoR related information for triggering a SoR procedure. The first secured packet is generated at an “application” layer (e.g., an application layer according to the OSI reference model, or 3GPP standards). In an example, this application key may be downloaded into the UICC through a “data download via SMS Point-to-Point” service, after an initial registration to a first VPLMN, or during the initial registration but after a primary authentication. Then, the UICC would maintain the first key for a SoR application.

At block 1170, the method comprises providing integrity protection to the first secured packet by using a second key. The second key is a key of network layer shared with the HPLMN. For example, the second key may be a UE-specific symmetric key (e.g., K_{AUSF}) derived from a primary authentication between the UE and the HPLMN. Then, at block 1180, the method comprises sending to the first VPLMN, a message comprising the first secured packet with integrity protection. For example, the message may be periodic registration request or a security mode complete message, sent to an AMF of the first VPLMN.

In some embodiments, the method 1100B may further comprise receiving SoR information from the HPLMN via the first VPLMN. The SoR information may comprise a second secured packet which is protected with symmetric keys of the first and second keys. In this regard, the the second secured packet may be integrity protected with a symmetric key (referred to as a fourth key), such as a K_{AUSF} by an AUSF node of the HPLMN. Furthermore, the second secured packet may be ciphered with an application key (referred to as a third key) corresponding to the first key by a SoR-AF of the HPLMN. Then, the method 1100B may further comprise checking the integrity of the received second secured packet by using the second key; and deciphering the second secured packet by using the first key in the UICC.

In some embodiments, the method 1100B may further comprise setting an ACK indication in the message to indicate that the UE needs an acknowledgement of a receipt of the first secured packet from the HPLMN; and determining whether the secured packet is sent successfully according to an ACK response for the first secured packet which is to be received from the HPLMN, in a similar way as described for the method 1100A.

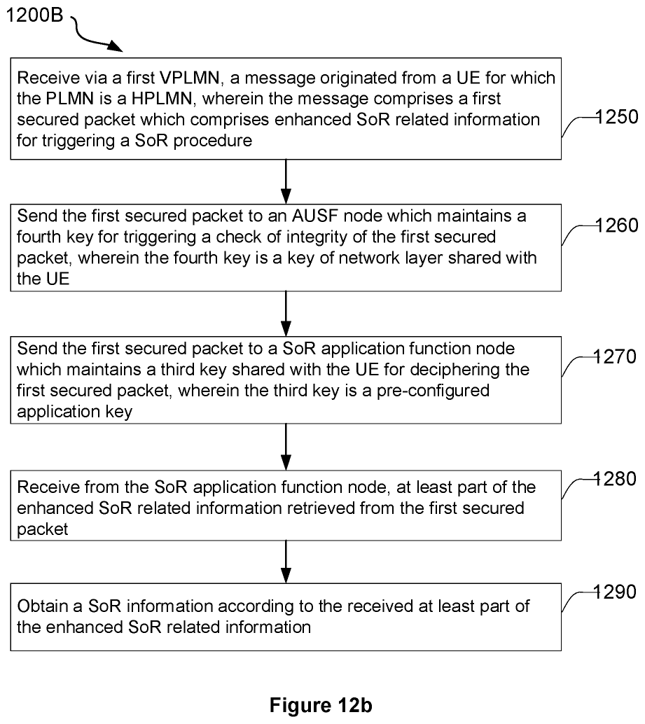

FIG. 12a is a flowchart of a method 1200A according to an embodiment of the present disclosure. The method 1200B can be implemented at any suitable device. For example, the method 1200B can be implemented at a UDM node, which is configured to implement the UDM 503, UDM 603, UDM 903 and UDM 1003.

At block 1210, the method 1200A comprises receiving via a first VPLMN, a message originated from a UE for which the PLMN of the UDM node is a HPLMN. The message comprises a first secured packet, which comprises enhanced SoR related information for triggering a SoR procedure. For example, the message may be an authentication request message or a UDM registration message for an initial registration of the UE.

At block 1220, the method 1200A comprises enabling verification of the first secured packet to retrieve the enhanced SoR related information, by one of the following operations: verifying at the UDM node, the first secured packet by using one or more keys; or sending the first secured packet to a network node which maintains the one or more keys. Each of the one or more keys is a symmetric key, which is available for the UE and the HPLMN before a primary authentication of an initial registration of the UE to the first VPLMN. The term “verify”, “verifying” or “verification” used in this disclosure refers to the use of security operations at a receiving side, such as decryption, integrity checking, and the like, which correspond to the security or protection operations executed in a transmitting side.

Then, at block 1230, the method 1200A comprises obtaining SoR information according to the retrieved enhanced SoR related information. The enhanced SoR related information for triggering the SoR procedure comprises at least one of the following: configured network slice selection assistance information (NSSAI) of a second VPLMN; corresponding mappings of one or more single NSSIAs (S-NSSAI) of the configured NSSAI to respective S-NSSAIs of the HPLMN; at least capability of the UE; a location of the UE; or NSSAI requested by the UE.

In some embodiments, the one or more keys comprise a third key for confidentiality protection. Then, enabling the verification of the first secured packet comprises: deciphering the first secured packet by using the third key. Alternatively or additionally, the one or more keys comprise a fourth key for integrity protection, and then enabling the verification of the first secured packet comprises: checking integrity of the first secured packet by using the fourth key.

In some embodiments, the one or more keys are shared in a UICC of the UE and a SoR application function node (such as the SoR-AF 504). The one or more keys are application keys which are pre-configured and maintained in the SoR application function node. Then, enabling the verification of the first secured packet may further comprise sending the first secured packet to the SoR application function node; and receiving at least part of the enhanced SoR related information from the SoR application function node. At least part of the enhanced SoR related information may be stored in the UDM node. The method 1200B may further comprise receiving from the SoR application function node, a second secured packet which is protected with the one or more keys; and sending the SoR information with the second secured packet to the UE.

In some embodiments, the one or more keys may be shared in a UICC of the UE and the UDM node (such as the UDM 903). Enabling the verification of the first secured packet may further comprise generating at the UDM node, each of the one or more keys from asymmetric key pairs used for a generation of SUCI; and verifying at the UDM node, the first secured packet by using the generated one or more keys.

In some embodiments, the one or more keys may be pre-configured keys of network layer. In an embodiment, these keys of network layer may be pre-configured in the UICC or ME of the UE and the UDM node (such as the UDM 903), before a primary authentication of an initial registration to the first VPLMN. Then, enabling the verification of the first secured packet may further comprise maintaining the one or more keys of network layer at the UDM node; and verifying at the UDM node, the first secured packet by using the one or more keys. These pre-configured keys of network layer are identified with respective key ID. Then, the method 1200A may further comprise receiving at least one key identity for at least one key of the one or more keys; and identifying the at least one key based on the received key identity. The method 1200A may further comprise creating a second secured packet which is protected with the one or more keys; and sending the SoR information with the second secured packet to the UE.

In another embodiment, these keys of network layer may be pre-configured in the UICC or ME of the UE and an AUSF node (such as the AUSF 905), before a primary authentication of an initial registration to the first VPLMN. Then, enabling the verification of the first secured packet may further comprise sending the first secured packet to the AUSF node; and receiving at least part of the enhanced SoR related information from the AUSF node. At least part of the enhanced SoR related information may be stored in the UDM node. The method 1200A may further comprise receiving at least one key identity for at least one key of the one or more keys; and sending the received key identity to the AUSF node. In an embodiment, the method 1200A may further comprise receiving from the AUSF node, a second secured packet which is protected with the one or more keys; and send the SoR information with the second secured packet to the UE.

In some embodiments, the method 1200A may further comprise receiving an ACK indication in the message; and in response to the ACK indication, sending the SoR information with an ACK response to the UE.

In some embodiments, the method 1200A may further comprise receiving a SoR indication in the message; using the SoR indication in a calculation of an authentication response parameter for an authentication with the UE; and determining whether the secured packet is received successfully according to a result of the authentication which is performed based on the authentication response parameter.

FIG. 12b is a flowchart of a method 1200B according to an embodiment of the present disclosure. The method 1200B can be implemented at any suitable device. For example, the method 1200B can be implemented at a UDM node, which is configured to implement the UDM 703 as shown in FIG. 7.

At block 1250, the method 1200B comprises receiving via a first VPLMN, a message originated from a UE for which the PLMN is a HPLMN. The message comprises a first secured packet which comprises enhanced SoR related information for triggering a SoR procedure.

At block 1260, the method 1200B comprises sending the first secured packet to an AUSF node (such as AUSF 705) which maintains a fourth key for triggering a verification of the integrity of the first secured packet. The fourth key is a key of network layer shared with the UE. The fourth key may be a UE-specific symmetric key (such as K_{AUSF}) derived from a primary authentication between the UE and the AUSF node.

At block 1270, the method 1200B comprises sending the first secured packet to a SoR application function node (such as SoR-AF 704) which maintains a third key shared with the UE for deciphering the first secured packet. The third key is a pre-configured application key.

At block 1280, the method 1200B comprises receiving from the SoR application function node, at least part of the enhanced SoR related information retrieved from the first secured packet.

At block 1290, the method 1200B comprises obtaining SoR information according to the received at least part of the enhanced SoR information. The enhanced SoR related information for triggering the SoR procedure comprises at least one of the following: configured network slice selection assistance information (NSSAI) of a second VPLMN; corresponding mappings of one or more single NSSIAs (S-NSSAI) of the configured NSSAI to respective S-NSSAIs of the HPLMN; at least one capability of the UE; a location of the UE; or NSSAI requested by the UE.

In some embodiments, the method 1200B may further comprise receiving from the SoR application function node, a second secured packet which is ciphered with the third key; and sending the SoR information with the second secured packet to the UE.

In some embodiments, the method 1200B may further comprise receiving an ACK indication in the message; and in response to the ACK indication, sending the SoR information with an ACK response to the UE.

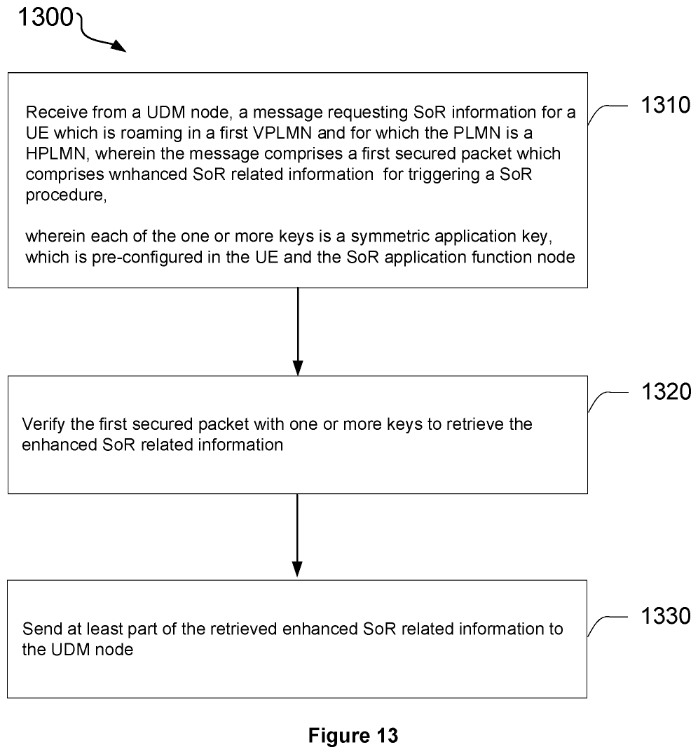

FIG. 13 is a flowchart of a method 1300 according to an embodiment of the present disclosure. The method 1300 can be implemented at any suitable device. For example, the method 1300 can be implemented at a SoR application function node, which is configured to implement the SoR-AF 504 and 704.

At block 1310, the method 1300 comprises receiving from a UDM node (such as UDM 503 and 703), a message requesting SoR information for a UE which is roaming in a first VPLMN and for which the PLMN of the SoR-AF is a HPLMN. The message comprises a first secured packet which comprises enhanced SoR related information for triggering a SoR procedure.

At block 1320, the method 1300 comprises verifying the first secured packet with one or more keys to retrieve the enhanced SoR related information. Each of the one or more keys is a symmetric application key, which is pre-configured in the UE and the SoR application function node.

At block 1320, the method 1300 comprises sending at least part of the retrieved enhancedSoR related information to the UDM node.

In some embodiments, the one or more keys may comprise a third key for confidentiality protection. Then, verifying the first secured packet may comprise: deciphering the first secured packet by using the third key. Alternatively or additionally, the one or more keys may comprise a fourth key for integrity protection, and then verifying the first secured packet comprises: checking integrity of the first secured packet by using the fourth key.

In some embodiments, the one or more keys are shared with the UE before a primary authentication of an initial registration of the UE to the first VPLMN.

In some embodiments, the third key is shared with the UE after a primary authentication of an initial registration of the UE to the first VPLMN.

In some embodiments, the method 1300 may further comprise sending to the UDM node, a second secured packet which is protected with the one or more keys.

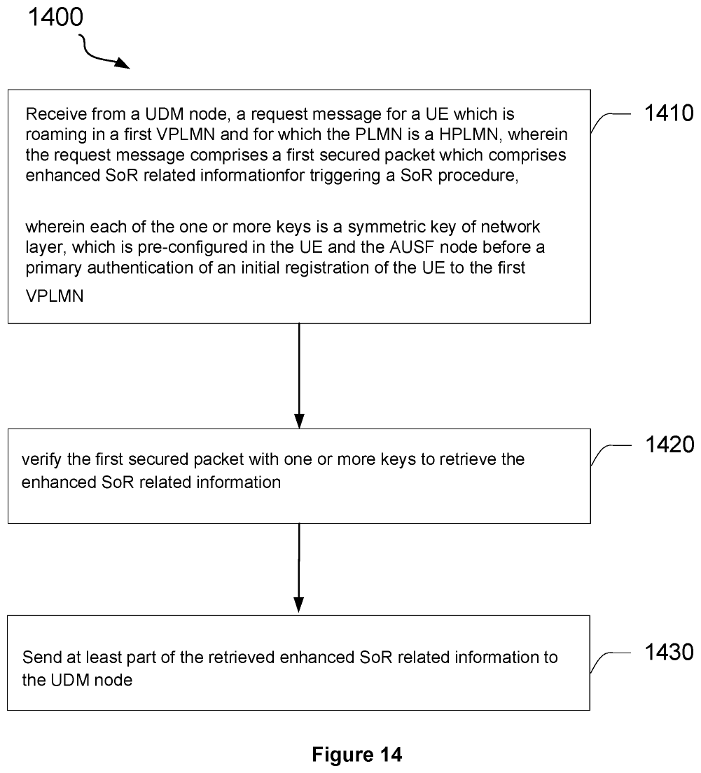

FIG. 14 is a flowchart of a method 1400 according to an embodiment of the present disclosure. The method 1400 can be implemented at any suitable device. For example, the method 1400 can be implemented at an authentication server function node, which is configured to implement the AUSF 1005.

At block 1410, the method 1400 comprises receiving from a UDM node (such as UDM 1003), a request message for a UE which is roaming in a first VPLMN and for which the PLMN of the AUSF node is a HPLMN. The request message comprises a first secured packet which comprisesenhanced SoR related information for triggering a SoR procedure.

At block 1420, the method 1400 comprises verifying the first secured packet with one or more keys to retrieve the enhanced SoR related information. Each of the one or more keys is a symmetric key of network layer, which is pre-configured in the UE and the AUSF node before a primary authentication of an initial registration of the UE to the first VPLMN

At block 1430, the method 1400 comprises send at least part of the retrieved enhanced SoR related information to the UDM node.

In some embodiments, the one or more symmetric keys may comprise a third key for confidentiality protection. Then, verifying the first secured packet may comprise deciphering the first secured packet by using the third key. Alternatively or additionally, the one or more symmetric keys may comprise a fourth key for integrity protection, and then verifying the first secured packet may comprise checking integrity of the first secured packet with the fourth key.

In some embodiments, the method 1400 may further comprise receiving from the UDM node, at least one key identity for at least one key of the one or more keys; and identifying the at least one key based on the received key identity.

In some embodiments, the method 1400 may further comprise creating a second secured packet which is protected with the one or more keys; and sending the second secured packet to the UDM node.

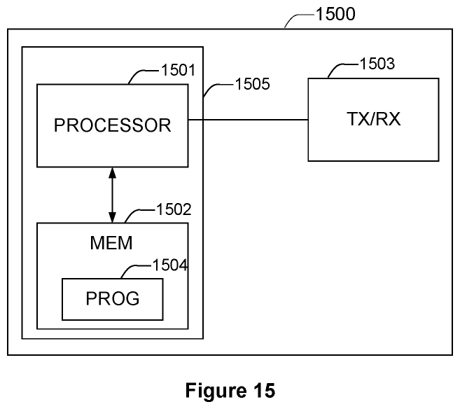

Now reference is made to FIG. 15 illustrating a simplified block diagram of an apparatus 1500 that may be embodied in/as a UE or network node (such as a UDM node, a SoR-AF node, an AUSF node). The apparatus 1500 may comprise at least one processor 1501, such as a data processor (DP) and at least one memory (MEM) 1502 coupled to the at least one processor 1501. The apparatus 1500 may further comprise one or more transmitters TX, one or more receivers RX 1503, or one or more transceivers coupled to the one or more processors 1501 to communicate wirelessly and/or through wireline.

Although not shown, the apparatus 1500 may have at least one communication interface, for example, the communicate interface can be at least one antenna, or transceiver as shown in the FIG. 15. The communication interface may represent any interface that is necessary for communication with other network entities.

The processors 1501 may be of any type suitable to the local technical environment, and may include one or more of the following: general purpose computers, special purpose computers, microprocessors, digital signal processors (DSPs) and processors based on multicore processor architecture, as non-limiting examples.

The MEMs 1502 may be of any type suitable to the local technical environment and may be implemented using any suitable data storage technology, such as semiconductor-based memory devices, magnetic memory devices and systems, optical memory devices and systems, fixed memory and removable memory, as non-limiting examples.

The MEM 1502 stores a program (PROG) 1504. The PROG 1504 may include instructions that, when executed on the associated processor 601, enable the apparatus 1500 to operate in accordance with the embodiments of the present disclosure, for example to perform one of the methods 1100A, 1100B, 1200A, 1200B, 1300, and 1400. A combination of the at least one processor 601 and the at least one MEM 1502 may form processing circuitry or means 1505 adapted to implement various embodiments of the present disclosure.

Various embodiments of the present disclosure may be implemented by computer program executable by one or more of the processors 1501, software, firmware, hardware or in a combination thereof.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosures may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosures may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium, for example, non-transitory computer readable medium, such as a hard disk, optical disk, removable storage media, solid state memory, RAM, etc. As will be appreciated by one of skills in the art, the function of the program modules may be combined or distributed as desired in various embodiments. In addition, the function may be embodied in whole or in part in firmware or hardware equivalents such as integrated circuits, field programmable gate arrays (FPGA), and the like. The term “non-transitory” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

The following abbreviations that may be found in the specification and/or the drawing figures are defined as follows:
3GPP 3rd Generation Partnership Project
5G 5th Generation
5GC 5th Generation Core (network)
5G-GUTI 5G-Globally Unique Temporary Identifier
5GS 5G System
ACK Acknowledge character
AN Access Network
AMF Access and Mobility management Function
AUSF AUthentication Server Function
CN Core Network
DL DownLink
HPLMN Home Public Land Mobile Network
IE Information Element
MAC-I Message Authentication Code-Integrity
NAS Non-Access Stratum
NW Network
NSSF Network Slice Selection Function
NSSAI Network Slice Selection Assistance Information
PLMN Public Land Mobile Network
SIM Subscriber Identity Module
SMS Short Messaging Service
SMS-SC SMS Service Center
SMS-PP SMS Point-to-Point
SN-name Serving Network Name
S-NSSAI Single-Network Slice Selection Assistance Information
SOR Steering of Roaming
SOR-CMCI Steering Of Roaming Connected Mode Control Information
SP-AF Secured Packet Application Function
SUCI SUbscription Concealed Identifier
SUPI SUbscription Permanent Identifier
TA Tracking Area
TPDU Transport Protocol Data Unit
UDM Unified Data Management
UE User Equipment
UICC Universal Integrated Circuit Card
UL UpLink
UPU UE Parameters Update
USIM Universal Subscriber Identity Module
VPLMN Visited Public Land Mobile Network

1-62. (canceled)

63. An apparatus implemented at a user equipment (UE), comprising:
one or more processors; and
one or more memories storing instructions that, when executed by the one or more processors, cause the apparatus at least to:
create a first secured packet which is protected with one or more keys, wherein the first secured packet comprises enhanced steering of roaming (SoR) related information for triggering a SoR procedure; and
send to a first visited public land mobile network (VPLMN), a message comprising the first secured packet,
wherein each of the one or more keys is a symmetric key, which is available for the UE and a home public land mobile network (HPLMN) of the UE before a primary authentication of an initial registration to the first VPLMN.

64. The apparatus according to claim 63, wherein the one or more keys comprise a first key for confidentiality protection, and wherein when the instructions executed by the one or more processors, further cause the apparatus at least to:
cipher the enhanced SoR related information by using the first key.

65. The apparatus according to claim 64, wherein the one or more keys comprises a second key for integrity protection, and wherein when the instructions executed by the one or more processors, further cause the apparatus at least to:
provide integrity protection for the enhanced SoR related information by using the second key.

66. The apparatus according to claim 63, wherein the message is an initial registration message.

67. The apparatus according to claim 63, further comprising a universal integrated circuit card (UICC) coupled to the one or more processor; and
wherein when the instructions executed by the one or more processors, further cause the apparatus at least to:
send to the UICC, a request for creating the first secured packet, wherein the request comprises the enhanced SoR related information for triggering the SoR procedure; and
perform a security protection for the enhanced SoR related information by using the one or more keys in the UICC, so as to create the first secured packet.

68. The apparatus according to claim 67, wherein the one or more keys are pre- configured application keys, and wherein when the instructions executed by the one or more processors, further cause the apparatus at least to:
maintain the one or more keys in the UICC.

69. The apparatus according to claim 67, wherein when the instructions executed by the one or more processors, further cause the apparatus at least to:
generate in the UICC, each of the one or more keys from asymmetric key pairs used for a generation of subscription concealed identifier (SUCI).

70. The apparatus according to claim 63, wherein the one or more keys are one or more pre-configured keys of network layer, and wherein when the instructions executed by the one or more processors, further cause the apparatus at least to:
maintain the one or more pre-configured keys of network layer at the UE.

71. The apparatus according to claim 70, wherein when the instructions executed by the one or more processors, further cause the apparatus at least to:
send to the HPLMN, at least one key identity of at least one key of the one or more keys.

72. The apparatus according to claim 63, wherein the enhanced SoR related information for triggering the SoR procedure comprises at least one of the following:
configured network slice selection assistance information (NSSAI) of a second VPLMN;
corresponding mappings of one or more single NSSIAs (S-NSSAI) of the configured NSSAI to respective S-NSSAIs of the HPLMN;
at least one capability of the UE;
a location of the UE; or NSSAI requested by the UE.

73. The apparatus according to claim 63, wherein when the instructions executed by the one or more processors, further cause the apparatus at least to:
receive SoR information from the HPLMN via the first VPLMN, wherein the SoR information comprises a second secured packet which is protected with one or more symmetric keys of the one or more keys; and
verify the second secured packet by using the one or more keys.

74. The apparatus according to claim 63, wherein when the instructions executed by the one or more processors, further cause the apparatus at least to:
set an ACK indication in the message to indicate that the UE needs an acknowledgement of a receipt of the first secured packet from the HPLMN; and
determine whether the first secured packet is sent successfully according to an ACK response for the first secured packet, which is to be received from the HPLMN.

75. The apparatus according to claim 74, wherein when the instructions executed by the one or more processors, further cause the apparatus at least to:
determine whether SoR information received from the HPLMN via the first VPLMN comprises the ACK response for the first secured packet.

76. The apparatus according to claim 63, wherein when the instructions executed by the one or more processors, further cause the apparatus at least to:
include a SoR indication into the message;
use the SoR indication in a calculation of an authentication parameter for an authentication with the HPLMN; and
include the authentication parameter in an authentication response to be sent to the HPLMN.

77. The apparatus according to claim 76, wherein when the instructions executed by the one or more processors, further cause the apparatus at least to:
receive from the HPLMN, a result of the authentication which is performed based on the authentication parameter; and
determine whether the secured packet is sent successfully according to the result of the authentication.

78. The apparatus according to claim 74, wherein when the instructions executed by the one or more processors, further cause the apparatus at least to:
in case that it is determined that the secured packet is not sent successfully, perform at least one of the following operations:
marking the first VPLMN as a suspicious VPLMN;
triggering a camping on another VPLMN; or
sending the first secured packet for triggering the SoR procedure to the HPLMN, via another network.

79. An apparatus implemented at a user equipment (UE), comprising:
one or more processors;
a universal integrated circuit card (UICC) coupled to the one or more processor; and
one or more memories storing instructions that, when executed by the one or more processors, cause the apparatus at least to:
maintain in the UICC, a first key which is a pre-configured application key shared with a home public land mobile network (HPLMN) of the UE;
create a first secured packet which is ciphered by using the first key in the UICC, wherein the first secured packet comprises enhanced steering of roaming (SoR) related information for triggering a SoR procedure;
provide integrity protection to the first secured packet by using a second key, which is a key of network layer shared with the HPLMN; and
send to a first visited public land mobile network (VPLMN), a message comprising the first secured packet with integrity protection.

80. The apparatus according to claim 79, wherein the second key is a UE-specific symmetric key derived from a primary authentication between the UE and the HPLMN.

81. The apparatus according to claim 79, wherein the enhanced SoR related information for triggering the SoR procedure comprises at least one of the following:
configured network slice selection assistance information (NSSAI) of a second VPLMN;
corresponding mappings of one or more single NSSIAs (S-NSSAI) of the configured NSSAI to respective S-NSSAIs of the HPLMN;
at least one capability of the UE;
a location of the UE; and
NSSAI requested by the UE.

82. The apparatus according to claim 79, wherein when the instructions executed by the one or more processors, further cause the apparatus at least to:
set an ACK indication in the message to indicate that the UE needs an acknowledgement of a receipt of the first secured packet from the HPLMN; and
determine whether the secured packet is sent successfully according to an ACK response for the first secured packet which is to be received from the HPLMN.
